(19) United States
(12) Patent Application Publication
(10) Pub. No.: US 2019/0057432 A1
(43) Pub. Date: Feb. 21, 2019

(54) SHOPPING SUPPORT SERVER AND METHOD

(71) Applicant: TOSHIBA TEC KABUSHIKI KAISHA, Tokyo (JP)

(72) Inventors: Naoki SEKINE, Mishima Shizuoka (JP); Masami TAKAHATA, Setagaya Tokyo (JP); Shogo WATADA, Mishima Shizuoka (JP)

(21) Appl. No.: 16/104,822

(22) Filed: Aug. 17, 2018

(30) Foreign Application Priority Data
Aug. 18, 2017 (JP) 2017-158043

(51) Int. Cl. G06Q 30/06

(52) U.S. Cl. CPC G06Q 30/0631; G06Q 30/0633

(57) ABSTRACT

A shopping support server comprises a communication interface through which a code of an item to be purchased is received, and a processor. The processor is configured to associate a first name with a second name, which is the name of the item to be purchased, if prior shopping lists having an item with the first name and associated with the item to be purchased satisfy a predetermined condition, and register as purchased an item in a current shopping list that has the first name.

### CROSS-REFERENCE TO RELATED APPLICATION

This application is based upon and claims the benefit of priority from Japanese Patent Application No. 2017-158043, filed Aug. 18, 2017, the entire contents of which are incorporated herein by reference.

### FIELD

Embodiments described herein relate generally to a shopping support apparatus, a shopping support method and a shopping support program.

### BACKGROUND

A shopping list application (hereinafter, referred to as a “list app”) capable of registering a commodity to be purchased to create a shopping list is known. The list app has a function of indicating whether or not the registered commodity is purchased based on an operation by a user. In such an app, a commodity with plural names may be registered in some cases. Then, there is a case in which a linkage dictionary for associating plural names is used such that the commodity is shown in a purchased state even in a case in which a name other than the name registered in the list app is input for the commodity. However, a creation and update of the linkage dictionary are performed through input by a user, which is troublesome.

### DESCRIPTION OF THE DRAWINGS

FIG. 1 is a block diagram illustrating an example of a configuration of a shopping support system according to an embodiment;

FIG. 2 is a block diagram illustrating an example of a configuration of a user terminal in the shopping support system according to the embodiment;

FIG. 3 is a diagram illustrating an example of a member table contained in a member DB in FIG. 1;

FIG. 4 is a diagram illustrating an example of a list table contained in a list DB in FIG. 1;

FIG. 5 is a diagram illustrating an example of a registration table contained in the list DB in FIG. 1;

FIG. 6 is a diagram illustrating an example of a dictionary table contained in a dictionary DB in FIG. 1;

FIG. 7 is a diagram illustrating an example of a configuration of records in an association table contained in an association DB in FIG. 1;

FIG. 8 is a diagram illustrating an example of a configuration of records in a commodity table contained in a commodity DB in FIG. 1;

FIG. 9 is a diagram illustrating an example of a configuration of records in a history table contained in a history DB in FIG. 1;

FIGS. 10-16 depict a flowchart of a process executed by a processor of the user terminal in FIG. 2;

FIGS. 17-19 depict a flowchart of a process executed by a processor of the support server in FIG. 1;

FIGS. 20-21 depict a flowchart of a process execute by a processor of a POS terminal in FIG. 2; and

FIG. 22 is a diagram illustrating an example of a list screen displayed on a display device of the user terminal in FIG. 2.

### DETAILED DESCRIPTION

In accordance with an embodiment, a shopping support server comprises a communication interface through which a code of an item to be purchased is received, and a processor. The processor is configured to associate a first name with a second name, which is the name of the item to be purchased, if prior shopping lists having an item with the first name and associated with the item to be purchased satisfy a predetermined condition, and register as purchased an item in a current shopping list that has the first name.

Hereinafter, a support system according to an embodiment will be described below with reference to the accompanying drawings.

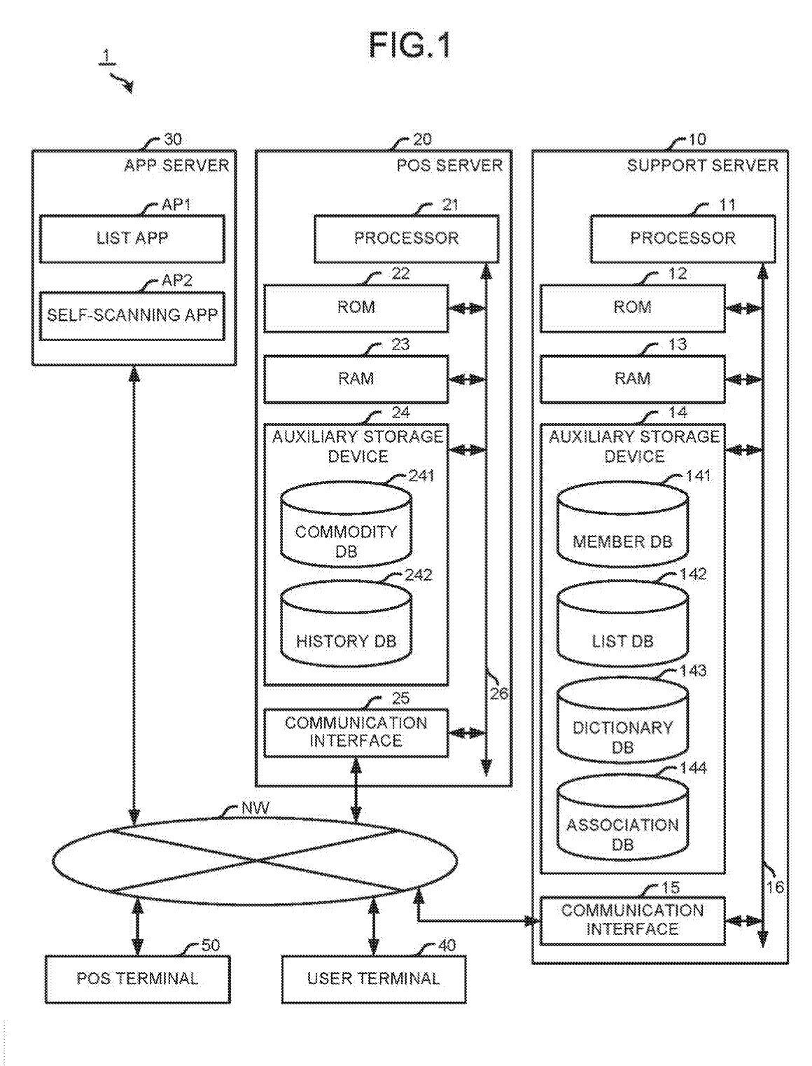

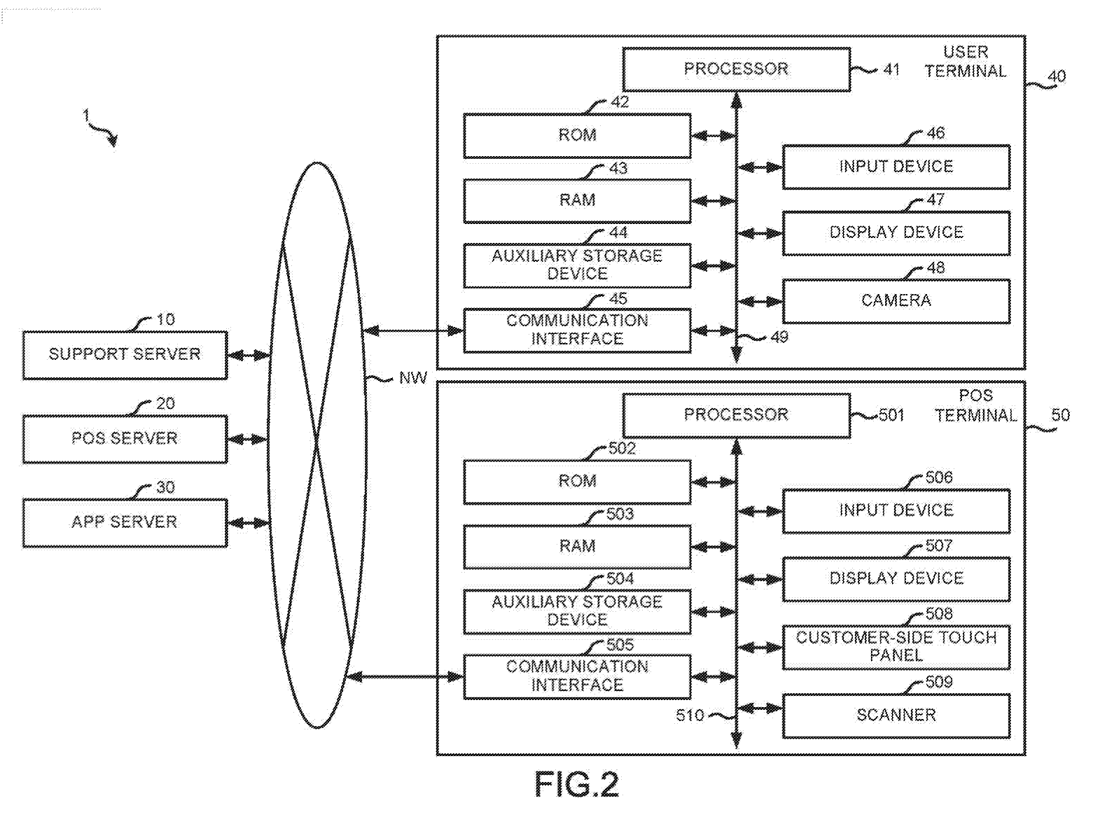

FIG. 1 and FIG. 2 are block diagrams illustrating an example of a configuration of a support system 1 and components of the support system 1 according to the embodiment. The support system 1 provides a shopping support service. The shopping support service includes a list service and a self-scanning service. The list service provides a shopping list that can be used in an information apparatus. A self-scanning service is a service with which a barcode attached to a commodity is read to perform a purchase registration on the commodity in a retail store. It is, however, not necessary to read the barcode attached to the commodity at a register for to perform the purchase registration on the commodity. The support system 1 includes a support server 10, a POS (Point Of Sale) server 20, an app server (application server) 30, a user terminal 40, and a POS terminal 50. The support server 10, the POS server 20, the app server 30, the user terminal 40, and the POS terminal 50 are connected to a network NW. The network NW is typically a communication network including an internet. The network NW may include an intranet, a public mobile telephone network, a public switched telephone network, or other communication network.

In FIG. 1 and FIG. 2, one support server 10, one POS server 20, one app server 30, one user terminal 40, and one POS terminal 50 are shown; however, the number of each of these devices is not limited to one.

The support server 10 is used to provide the shopping support service. The support server 10 includes a processor 11, a ROM (Read-Only Memory) 12, a RAM (Random-Access Memory) 13, an auxiliary storage device 14, a communication interface 15 and a bus 16.

The processor 11 is a central part of a computer which performs processes such as an arithmetic process and a control process necessary for the operation of the support server 10. The processor 11 executes a program such as a system software, an application software or a firmware stored in the ROM 12 or the auxiliary storage device 14 to control each section to realize various functions of the support server 10. The processor 11 is, for example, a CPU (Central Processing Unit), a MPU (Micro Processing Unit), a SoC (System on a Chip), a DSP (Digital Signal Processor), or a GPU (Graphics Processing Unit). Alternatively, the processor 11 may be a combination of these. The processor 11 is an example of a controller. The computer with the processor 11 as the central part thereof is an example of the controller.

The ROM 12 is a read-only nonvolatile memory. The ROM 12 stores the above program. The ROM 12 also stores data used for the processor 11 to perform various processes or various setting values.

The RAM 13 is a memory used for reading and writing data. The RAM 13 is used as a so-called work area for storing data temporarily used by the processor 11 to perform various processes.

The auxiliary storage device 14 is, for example, an EEPROM (Electric Erasable Programmable Read-Only Memory), a HDD (Hard Disk Drive), a SSD (Solid State Drive), or the like. The auxiliary storage device 14 may store the above program. The auxiliary storage device 14 stores data used by the processor 11 to perform various processes, data generated by process by the processor 11, or various setting values.

The auxiliary storage device 14 stores a member DB (database) 141, a list DB 142, a dictionary DB 143, and an association DB 144.

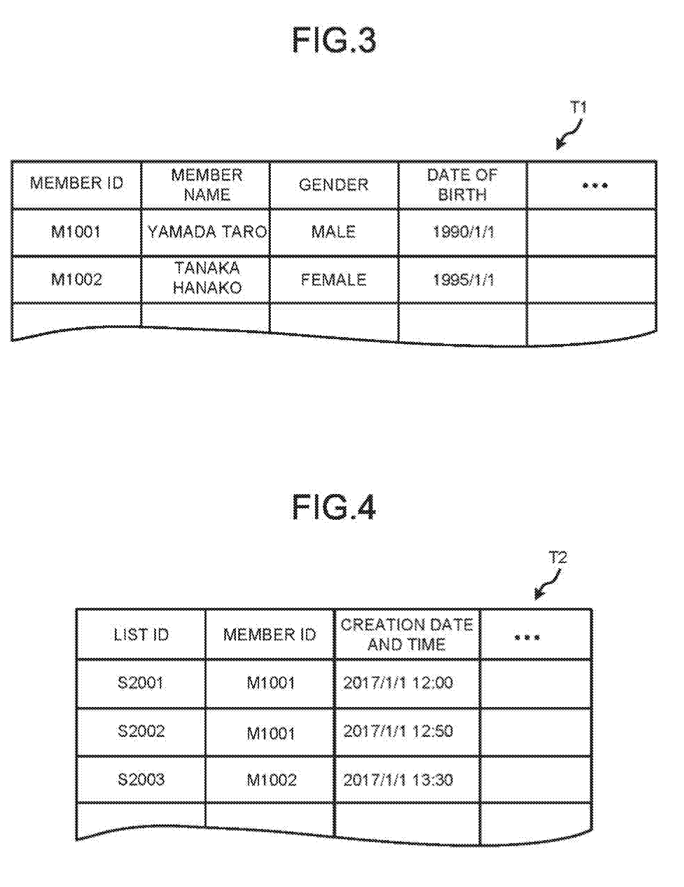

The member DB 141 stores information relating to a member of the shopping support service and the like. The member DB 141 includes, for example, a member table T1 as shown in FIG. 3. FIG. 3 is a diagram illustrating an example of the member table T1. In the member table T1, a member ID (identifier), a member name, gender, date of birth, etc. of the member identified by the member ID are associated with each other. The member ID is an identification code uniquely assigned to each member of the shopping support service.

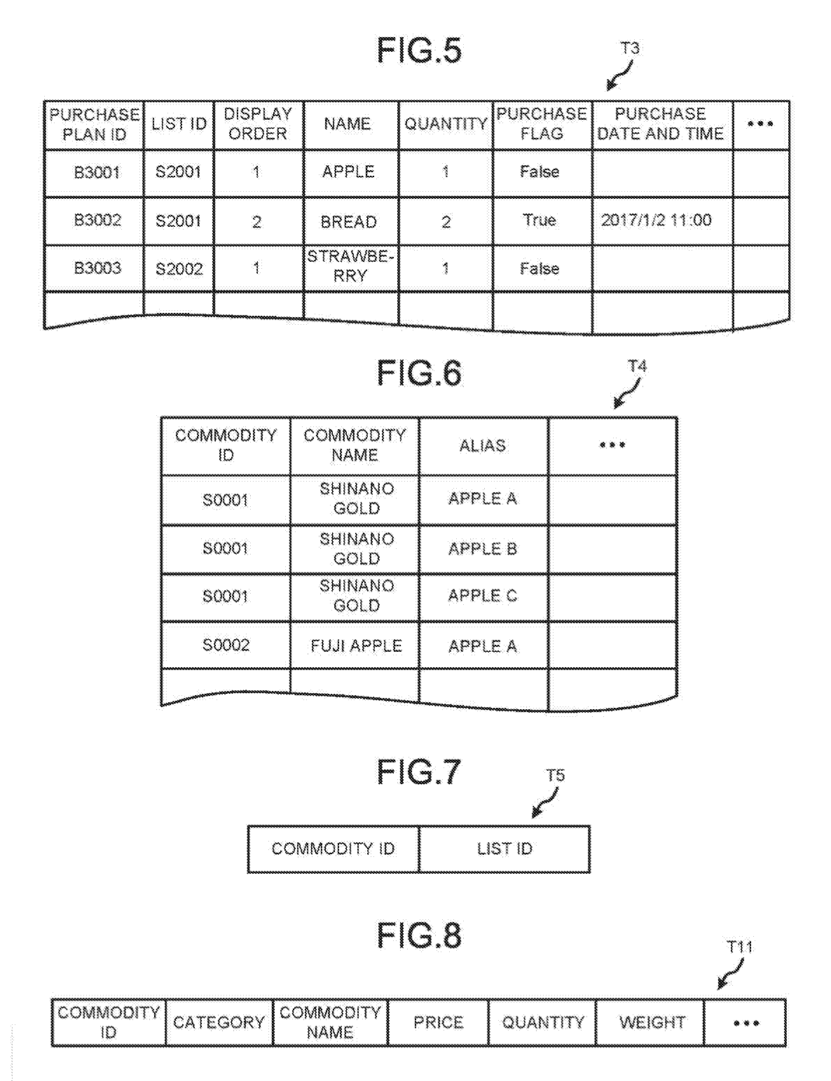

The list DB 142 stores information relating to the shopping list. The list DB 142 includes a list table T2 as shown in FIG. 4 and a registration table T3 as shown in FIG. 5. FIG. 4 is a diagram illustrating an example of the list table T2. FIG. 5 is a diagram illustrating an example of the registration table T3.

In the list table T2, a list ID, a member ID of a member who creates the shopping list specified by the list ID, a creation date and time of the shopping list specified by the list ID, and the like are associated with each other. The list ID is an identification code uniquely assigned to each shopping list.

The registration table T3 stores a purchase plan ID, a list ID of a shopping list in which the purchase-planned commodity specified by the purchase plan ID is registered, a display order indicating which rank of the purchase-planned commodity to be displayed is in the shopping list, a name indicating the purchase-planned commodity, a planned purchase quantity of the purchase-planned commodity, a purchase flag indicating that the purchase-planned commodity is already purchased, a purchase date and time of the purchase-planned commodity, and the like in an associated manner. The purchase plan ID is an identification code uniquely assigned to the purchase-planned commodity contained in the shopping list.

The dictionary DB 143 stores a linkage dictionary that associates the commodity name of the commodity with an alias of the commodity. The dictionary DB 143 includes a dictionary table T4 as shown in FIG. 6. For each of plural commodities, the dictionary table T4 associates the commodity ID and the commodity name with the alias of the commodity. The commodity ID is an identification code uniquely assigned to each commodity.

The association DB 144 includes an association table T5 as shown in FIG. 7. FIG. 7 is a diagram illustrating an example of a configuration of records in the association table T5. The association table T5 associates the commodity ID with the list ID. The association table T5 associates the commodity purchased based on the shopping list with the shopping list.

The program stored in the ROM 12 or the auxiliary storage device 14 includes a control program for executing processes described later. As an example, the support server 10 is accessed by an administrator or the like of the support server 10 with the control program stored in the ROM 12 or the auxiliary storage device 14. However, the support server 10 may be accessed by the administrator or the like in a state in which the control program for executing processes described later is not stored in the ROM 12 or the auxiliary storage device 14. The support server 10 may be accessed by the administrator or the like with another control program stored in the ROM 12 or the auxiliary storage device 14. Then, the control program for executing the processes described later may be separately transferred, and may be written into the ROM 12 or the auxiliary storage device 14 under the operation of the administrator or a service person. The transfer of the control program at this time may be realized by recording the control program on a removable storage medium such as a magnetic disk, a magneto-optical disk, an optical disk, a semiconductor memory or the like, or by downloading the control program via the network NW.

The communication interface 15 is an interface through which the support server 10 communicates via the network NW or the like. The communication interface 15 is an example of a first communication section.

The bus 16 includes a control bus, an address bus, a data bus, and the like, and transmits signals transmitted and received to and from respective sections of the support server 10.

The POS server 20 is used for operating a POS system. The POS server 20 is installed, for example, for each retail store or a shop. The POS server 20 stores data relating to commercial transactions on the POS system. The POS server 20 includes a processor 21, a ROM 22, a RAM 23, an auxiliary storage device 24, a communication interface 25, and a bus 26.

The processor 21 acts as a central part of a computer which performs processes such as an arithmetic process and a control process necessary for the operation of the POS server 20. The processor 21 executes a program such as a system software, an application software or a firmware stored in the ROM 22 or the auxiliary storage device 24 to control each section to realize various functions of the POS server 20. The processor 21 is, for example, a CPU, a MPU, a SoC, a DSP, or a GPU. Alternatively, the processor 21 may be a combination of those.

The ROM 22 is a read-only nonvolatile memory. The ROM 22 stores the above program. The ROM 22 stores data used for the processor 21 to perform various processes or various setting values.

The RAM 23 is a memory used for reading and writing data. The RAM 23 is used as a so-called work area for storing data temporarily used by the processor 21 to perform various processes.

The auxiliary storage device 24 is, for example, an EEPROM, a HDD, a SSD, or the like. The auxiliary storage device 24 may store the above program. The auxiliary storage device 24 stores data used by the processor 21 to perform various processes, data generated by process by the processor 21, or various setting values.

Furthermore, the auxiliary storage device 24 stores a commodity DB 241 and a history DB 242.

The commodity DB 241 stores information relating to each commodity. The commodity DB 241 includes, for example, a commodity table T11 as shown in FIG. 8. FIG. 8 is a diagram illustrating an example of a configuration of records in the commodity table T11. The commodity table T11 associates the commodity ID with the commodity information such as a category, a commodity name, a price, an inventory quantity and a weight of the commodity specified by the commodity ID.

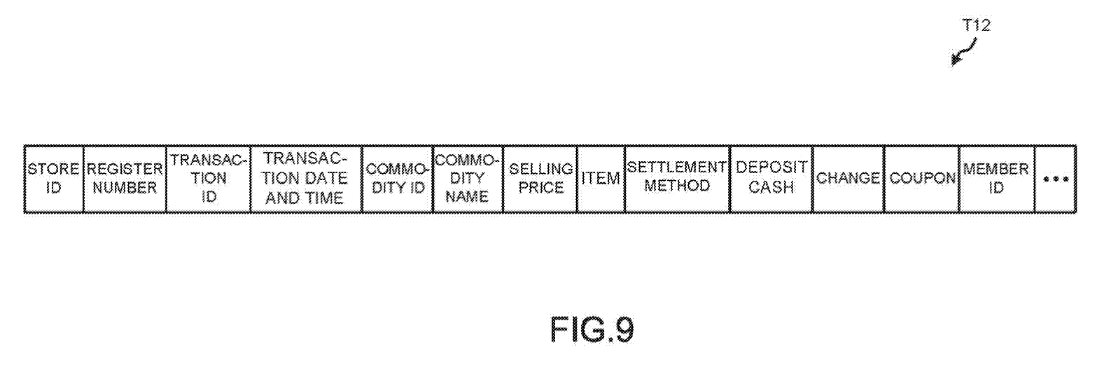

The history DB 242 stores a sales record of the commodity. The history DB 242 includes, for example, a history table T12 as shown in FIG. 9. FIG. 9 is a diagram illustrating an example of a structure of records in the history table T12. The history table T12 associates a transaction ID with sales information relating to the transaction ID. The transaction ID is an identification code uniquely assigned to each commercial transaction. The history DB 242 also associates the transaction ID with the list ID.

The program stored in the ROM 22 or the auxiliary storage device 24 includes a control program for executing processes described later. As an example, the POS server 20 is accessed by an administrator or the like of the POS server 20 with the control program stored in the ROM 22 or the auxiliary storage device 24. However, the POS server 20 may be accessed by the administrator or the like in a state in which the control program for executing processes described later is not stored in the ROM 22 or the auxiliary storage device 24. The POS server 20 may be accessed by the administrator or the like with another control program stored in the ROM 22 or the auxiliary storage device 24. Then, the control program for executing the processes described later may be separately transferred, and may be written into the ROM 22 or the auxiliary storage device 24 under the operation of the administrator or a service person. The transfer of the control program at this time may be realized by recording the control program on a removable storage medium such as a magnetic disk, a magneto-optical disk, an optical disk, a semiconductor memory or the like, or by downloading the control program via the network NW.

The communication interface 25 is an interface through which the POS server 20 communicates via the network NW or the like.

The bus 26 includes a control bus, an address bus, a data bus, and the like, and transmits signals transmitted and received to and from respective sections of the POS server 20.

The app server 30 stores application software such as a list app (list application) AP1 and a self-scanning app (self-scanning application) AP2. In addition, the app server 30 transmits the list app AP1 or the self-scanning app AP2 in response to a request.

The list app AP1 is application software used when the list service is used. The list app AP1 may be list service software, a general-purpose web browser or the like.

The self-scanning app AP2 is application software used when a self-scanning service is used. The self-scanning app AP2 may be software for self-scanning service, a general-purpose web browser, or the like.

The user terminal 40 is operated by a user of the shopping support service. The user terminal 40 is, for example, a mobile phone such as a smart phone, a PC (personal computer), a tablet PC, or the like. The user terminal 40 includes a processor 41, a ROM 42, a RAM 43, an auxiliary storage device 44, a communication interface 45, an input device 46, a display device 47, a camera 48 and a bus 49. The user terminal 40 is an example of a terminal device.

The processor 41 acts as a central part of a computer which performs processes such as an arithmetic process and a control process necessary for the operation of the user terminal 40. The processor 41 executes a program such as a system software, an application software or a firmware stored in the ROM 42 or the auxiliary storage device 44 to control each section to realize various functions of the user terminal 40. The processor 41 is, for example, a CPU, a MPU, a SoC, a DSP, or a GPU. Alternatively, the processor 41 may be a combination of those.

The ROM 42 is a read-only nonvolatile memory. The ROM 42 stores the above program. The ROM 42 stores data used for the processor 41 to perform various processes or various setting values.

The RAM 43 is a memory used for reading and writing data. The RAM 43 is used as a so-called work area for storing data temporarily used for the processor 41 to perform various processes.

The auxiliary storage device 44 is, for example, an EEPROM, a HDD, a SSD, or the like. The auxiliary storage device 44 may store the above program. The auxiliary storage device 44 stores data used by the processor 41 to perform various processes, data generated by process by the processor 41, or various setting values.

Further, the RAM 43 or the auxiliary storage device 44 stores the member ID.

The program stored in the ROM 42 or the auxiliary storage device 44 includes the list app and the self-scanning app as application software for executing processes described later. As an example, the user terminal 40 is accessed by an administrator or the like of the user terminal 40 with the list app and the self-scanning app stored in the ROM 42 or the auxiliary storage device 44. Then, the list app and the self-scanning app to be separately transferred may be written into the auxiliary storage device 44 under the operation of the administrator or the like. However, the user terminal 40 may be accessed by the administrator or the like in a state in which the list app and the self-scanning app are stored in the ROM 42 or the auxiliary storage device 44. The transfer of the list app and the self-scanning app in this example may be realized by recording them on a removable storage medium such as a magnetic disk, a magneto-optical disk, an optical disk, a semiconductor memory or the like, or by downloading them via the network NW from the app server 30.

The communication interface 45 is an interface through which the user terminal 40 communicates via the network NW or the like. The communication interface 45 is an example of a second communication section.

The input device 46 receives an operation by an operator of the user terminal 40. The input device 46 is, for example, a keyboard, a keypad, a touch pad, a mouse, or the like.

The display device 47 displays a screen for notifying the operator of the user terminal 40 of various information. The display device 47 is, for example, a liquid crystal display, an organic EL (electro-luminescence) display or the like. As the input device 46 and the display device 47, a touch panel may also be used. A display panel of the touch panel can be used as the display device 47, and a touch pad of the touch panel can be used as the input device 46. The display device 47 is an example of a display section.

The camera 48 captures a barcode or the like.

The bus 49 includes a control bus, an address bus, a data bus, and the like, and transmits signals transmitted and received to and from respective sections of the user terminal 40.

The POS terminal 50 is installed in a shop such as a supermarket or a convenience store. The POS terminal 50 is installed to perform register tasks such as a purchase registration of the commodity to be settled and settlement of the registered commodity. The POS terminal 50 is operated mainly by, for example, a store clerk of the retail store. The POS terminal 50 may be a self-checkout type terminal operated by a customer or the like in the retail store. The POS terminal 50 may be a semi-self-service type terminal including a registration apparatus for performing the purchase registration of the commodity and a settlement apparatus for performing settlement of the registered commodity. Typically, in the semi-self-service type POS terminal 50, the registration apparatus is operated by the store clerk, and the settlement apparatus is operated by the customer. A unique POS ID is assigned to each POS terminal 50. A barcode for recording the POS ID is attached to each POS terminal 50. As an example, the following description is made by assuming that the POS terminal 50 is mainly operated by the store clerk. The POS terminal 50 includes a processor 501, a ROM 502, a RAM 503, an auxiliary storage device 504, a communication interface 505, an input device 506, a display device 507, a customer-side touch panel 508, a scanner 509, and a bus 510.

The processor 501 acts as a central part of a computer which performs processes such as an arithmetic process and a control process necessary for the operation of the POS terminal 50. The processor 51 executes a program such as a system software, an application software or a firmware stored in the ROM 502 or the auxiliary storage device 504 to control each section to realize various functions of the POS terminal 50. The processor 501 is, for example, a CPU, a MPU, a SoC, a DSP, or a GPU. Alternatively, the processor 501 may be a combination of those.

The ROM 502 is a read-only nonvolatile memory. The ROM 502 stores the above program. The ROM 502 stores data used for the processor 501 to perform various processes or various setting values.

The RAM 503 is a memory used for reading and writing data. The RAM 503 is used as a so-called work area for storing data temporarily used for the processor 501 to perform various processes.

The auxiliary storage device 504 is, for example, an EEPROM, a HDD, a SSD, or the like. The auxiliary storage device 504 may store the above program. The auxiliary storage device 504 stores data used by the processor 501 to perform various processes, data generated by process by the processor 501, or various setting values. The auxiliary storage device 504 also stores the commodity list which is a list of commodities registered as purchased commodities. Alternatively, the RAM 503 may store the commodity list. Furthermore, the auxiliary storage device 504 also stores a commodity database including various information such as the commodity code, the commodity name and an amount of the commodity being sold in the retail store.

The program stored in the ROM 502 or the auxiliary storage device 504 includes a control program for executing processes described later. As an example, the POS terminal 50 is accessed by an administrator or the like of the POS terminal 50 with the control program for executing the processes described later stored in the ROM 502 or the auxiliary storage device 504. However, the POS terminal 50 may be accessed by the administrator or the like in a state in which the control program for executing processes described later is not stored in the ROM 502 or the auxiliary storage device 504. The POS terminal 50 maybe accessed by the administrator or the like with another control program stored in the ROM 502 or the auxiliary storage device 504. Then, the control program for executing the processes described later may be separately transferred and written into the ROM 502 or the auxiliary storage device 504 under the operation of the administrator or a service person. The transfer of the control program at this time may be realized by recording the control program on a removable storage medium such as a magnetic disk, a magneto-optical disk, an optical disk, a semiconductor memory or the like, or by downloading the control program via the network NW.

The communication interface 505 is an interface through which the POS terminal 50 communicates via the network NW or the like.

The input device 506 receives an operation by an operator of the POS terminal 50. The input device 506 is, for example, a keyboard, a keypad, a touch pad, a mouse, or the like.

The display device 507 displays a screen for notifying the operator of the POS terminal 50 of various information. The display device 507 is, for example, a liquid crystal display, an organic EL display or the like. As the display device 507, a display panel superimposed on a touch panel may also be used. The display panel of the touch panel can be used as the display device 507, and the touch pad of the touch panel can be used as the input device 506.

The customer-side touch panel 508 functions as a display device for displaying a screen for notifying a customer of various information. The customer-side touch panel 508 functions as an input device for receiving a touch operation by the customer. As described above, the operator of the POS terminal 50 is mainly the store clerk, but for the customer-side touch panel 508, the customer is the operator.

The scanner 509 reads a barcode displayed on the commodity or the like and outputs a commodity code indicated by the barcode. The scanner 509 may be a scanner held by the operator with a hand or a scanner fixed to a checkout table or the like.

The bus 510 includes a control bus, an address bus, a data bus, and the like, and transmits signals transmitted and received to and from respective sections of the POS terminal 50.

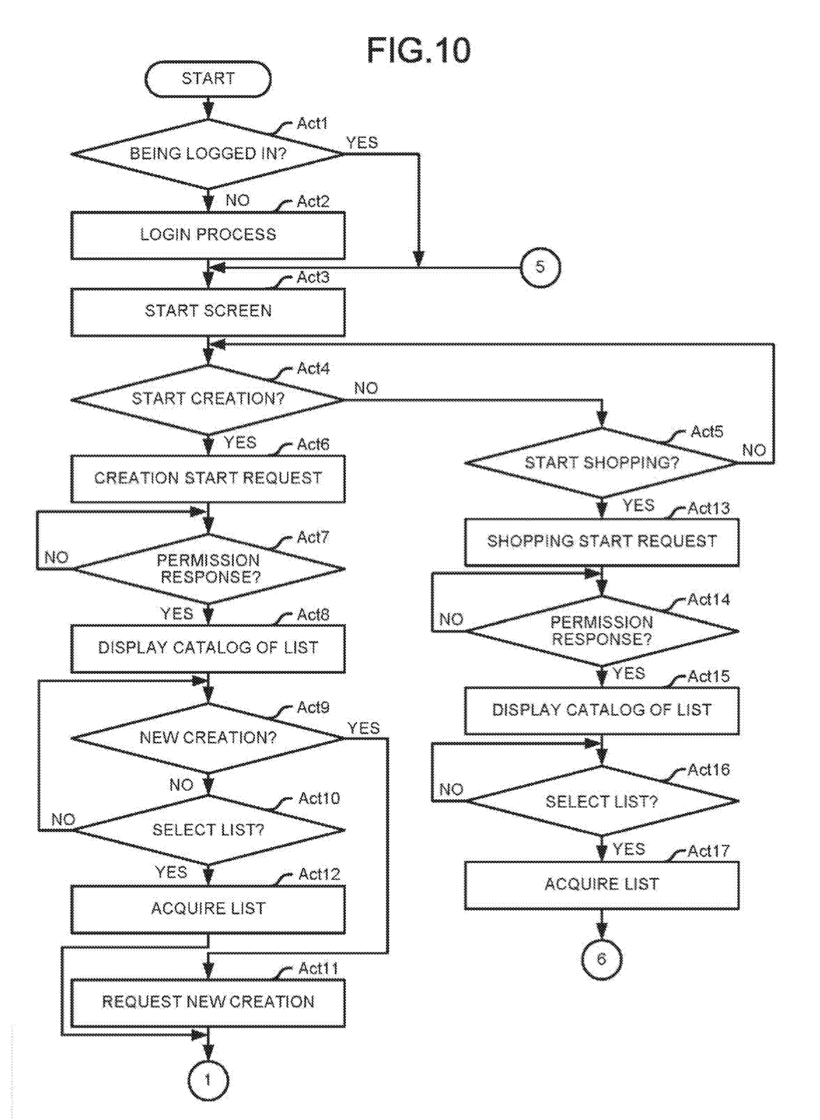

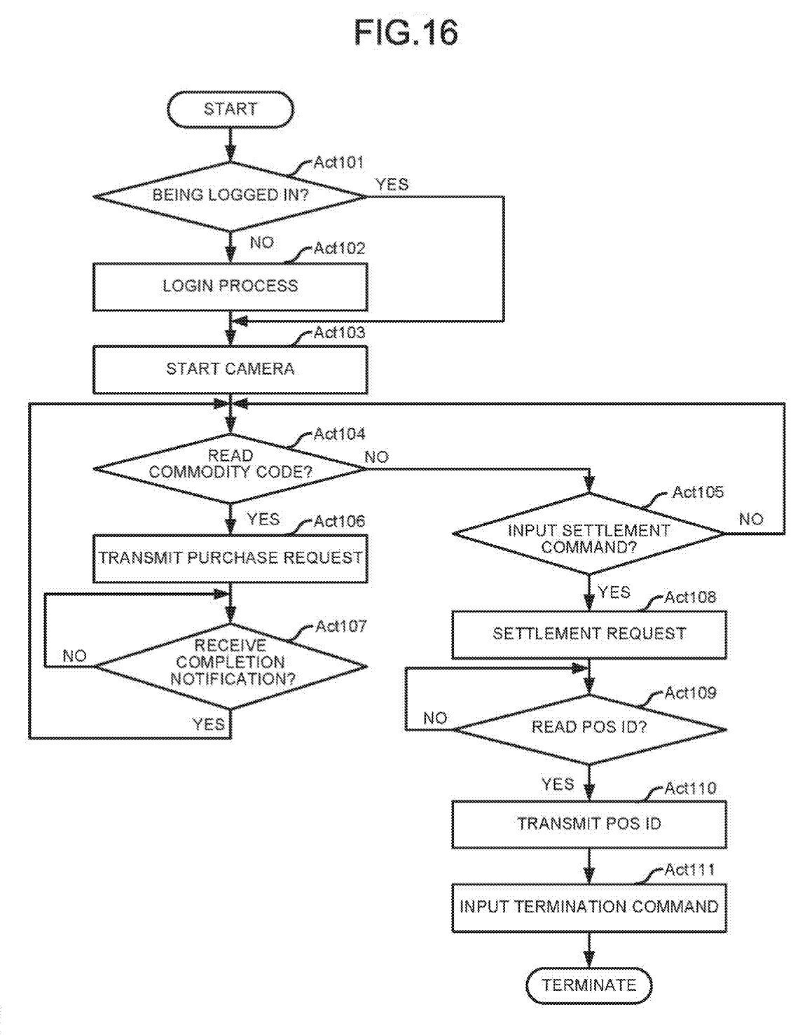

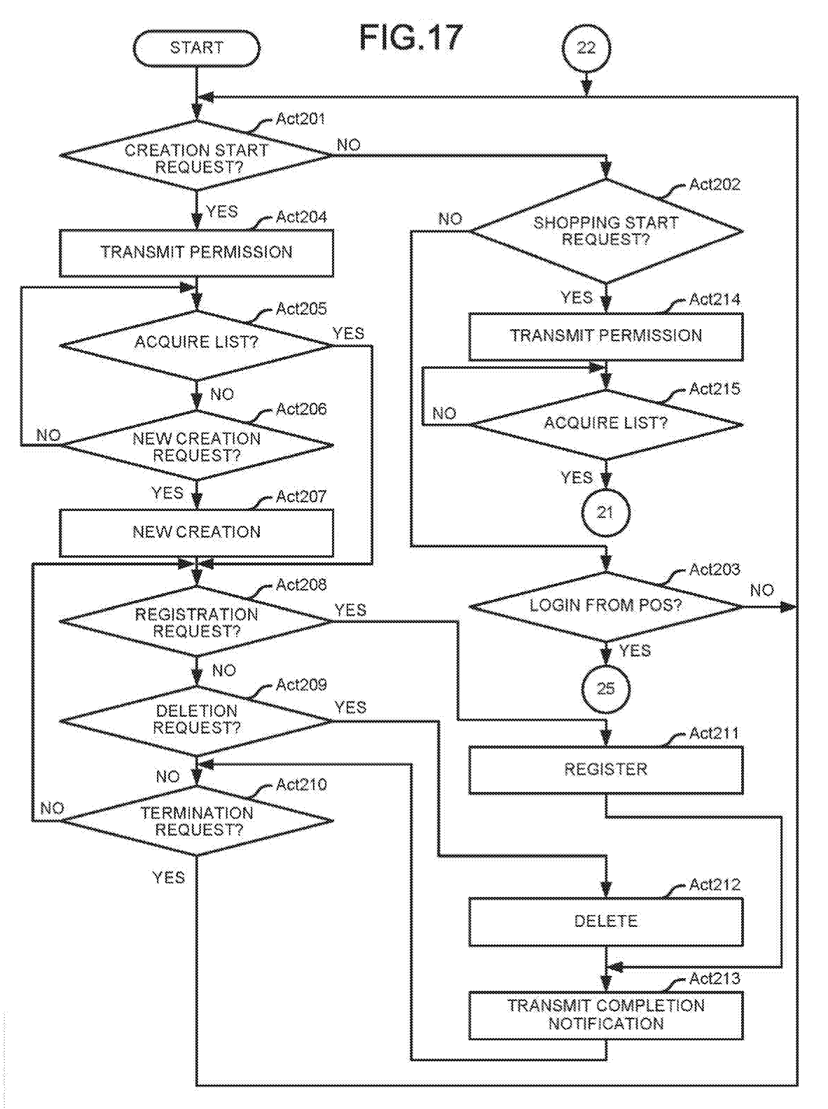

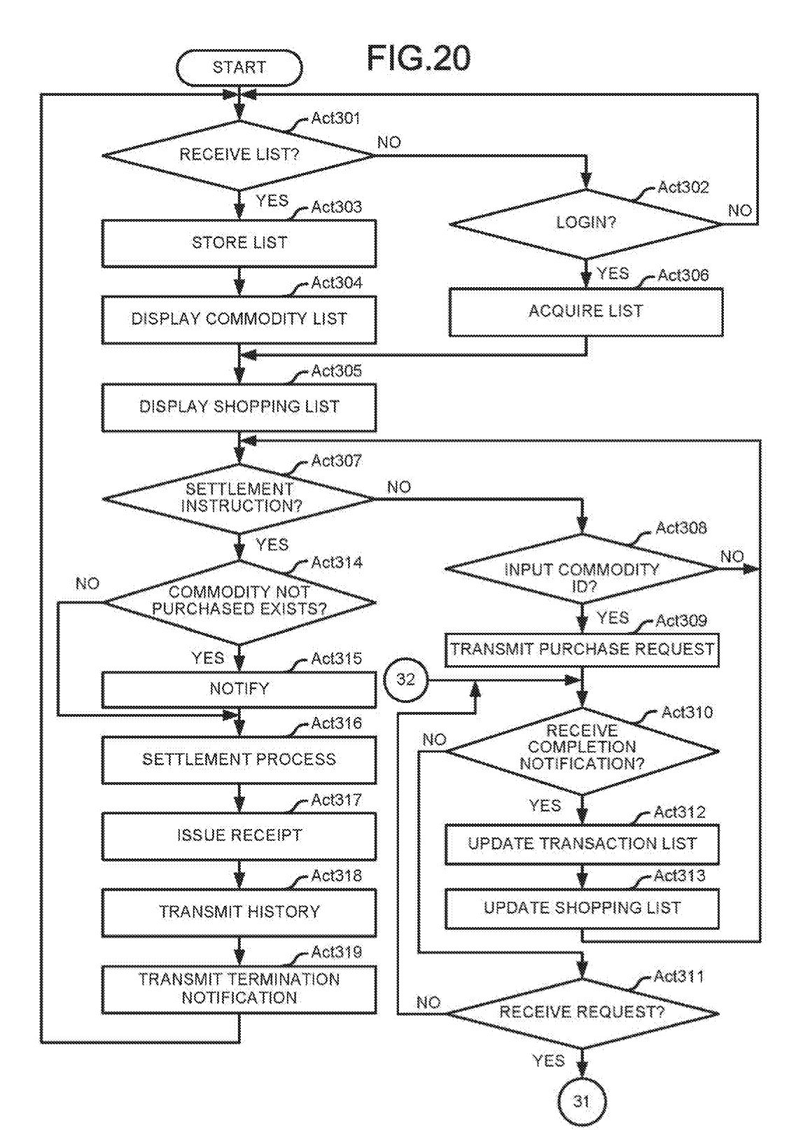

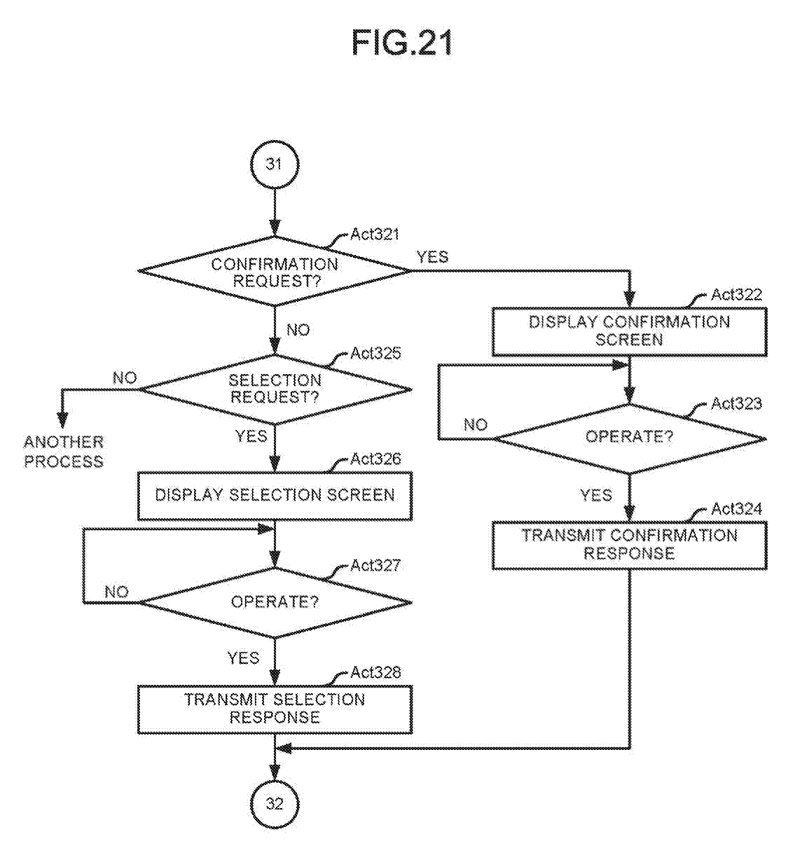

Hereinafter, the operation of the support system 1 according to the embodiment is described with reference to FIG. 10 to FIG. 22. The contents of the processes in the following operation description are merely an example, and various processes capable of achieving the same result can be suitably used. FIG. 10 to FIG. 16 are flowcharts for depicting processes executed by the processor 41 of the user terminal 40. The processor 41 executes the processes shown in FIG. 10 to FIG. 15 based on the list app stored in the ROM 42 or the auxiliary storage device 44. The processor 41 executes the process shown in FIG. 16 based on the self-scanning app stored in the ROM 42 or the auxiliary storage device 44. FIG. 17 to FIG. 19 are flowcharts for depicting processes by the processor 11 of the support server 10. The processor 11 executes the processes based on the control program stored in the ROM 12 or the auxiliary storage device 14. FIG. 20 and FIG. 21 are flowcharts for depicting processes by the processor 501 of the POS terminal 50. The processor 501 executes the processes based on the control program stored in the ROM 502 or the auxiliary storage device 504. Unless special description is provided, it is assumed that the processor 11, the processor 41 and the processor 501 proceed to the process in Act (n+1) after the process in Act (n) (n is a natural number). In the following description, the process performed by the support server 10 is performed for one user terminal 40 or one POS terminal 50. Actually, the support server 10 performs the same process respectively for each of the plurality of the user terminals 40 and the plurality of POS terminals 50.

In Act 1 in FIG. 10, the processor 41 of the user terminal 40 determines whether or not the user terminal 40 logs into the list service. If the user terminal 40 logs into the list service, the processor 41 determines Yes in Act 1 and proceeds to the process in Act 3. On the other hand, if the user terminal 40 does not log into the list service, the processor 41 determines No in Act 1 and proceeds to the process in Act 2.

In Act 2, the processor 41 performs a login process such that the user terminal 40 logs into the list service. For the login process, well-known methods can be used. Through the login process, the RAM 43 or the auxiliary storage device 44 stores the member ID used for login. The support server 10 identifies that the user terminal 40 logs into the list service using the member ID.

In Act 3, the processor 41 generates an image corresponding to a start screen. Then, the processor 41 instructs the display device 47 to display the generated image. Upon receiving the instruction, the display device 47 displays the start screen.

The start screen includes, for example, a creation start button and a shopping start button. The creation start button is operated by the operator at the time of creating the shopping list. The shopping start button is operated by the operator at the time of starting shopping using the created shopping list.

In Act 4, the processor 41 determines whether or not an operation for instructing the start of creating a shopping list is performed. Specifically, the processor 41 determines whether or not a predetermined operation such as operating the creation start button is performed. If the operation for instructing the start of creating the shopping list is not performed, the processor 41 determines No in Act 4 and proceeds to the process in Act 5.

In Act 5, the processor 41 determines whether or not an operation for instructing the start of shopping is performed. Specifically, the processor 41 determines whether or not a predetermined operation such as operating the shopping start button is performed. If the operation for instructing the start of the shopping is not performed, the processor 41 determines No in Act 5 and returns to the process in Act 4. Thus, the processor 41 repeats the processes in Act 4 and Act 5 until the operation for instructing the start of creating the shopping list is performed or the operation for instructing the start of shopping is performed.

The operator of the user terminal 40 operates the creation start button when a shopping list is to be edited or created with a method of editing a stored shopping list or a method of newly creating and editing the shopping list.

If the operation for instructing the start of creating the shopping list is performed in a standby state in Act 4 and Act 5, the processor 41 determines Yes in Act 4 and proceeds to the process in Act 6.

In Act 6, the processor 41 generates the creation start request for creating the shopping list. The creation start request includes the member ID stored in the RAM 43 or the auxiliary storage device 44. Then, the processor 41 instructs the communication interface 45 to transmit the generated creation start request to the support server 10. Upon receiving the instruction, the communication interface 45 transmits the creation start request to the support server 10. The transmitted creation start request is received by the communication interface 15 of the support server 10.

Meanwhile, in Act 201 in FIG. 17, the processor 11 of the support server 10 determines whether or not the creation start request is received by the communication interface 15. If the creation start request is not received, the processor 11 determines No in Act 201 and proceeds to the process in Act 202.

In Act 202, the processor 11 determines whether or not a shopping start request is received by the communication interface 15. If the shopping start request is not received, the processor 11 determines No in Act 202 and proceeds to the process in Act 203. The shopping start request is described later.

In Act 203, the processor 11 determines whether or not login is performed from the POS terminal 50. If the login is not performed from the POS terminal 50, the processor 11 determines No in Act 203 and returns to the process in Act 201. Thus, the processor 11 repeats the processes in Act 201 to Act 203 until the creation start request or the shopping start request is received or until the login is performed from the POS terminal 50.

If the creation start request is received in the standby state in Act 201 to Act 203, the processor 11 determines Yes in Act 201 and proceeds to the process in Act 204.

In Act 204, the processor 11 generates a creation permission response indicating permission to create the shopping list. The creation permission response includes a catalog of the shopping list associated with the member ID contained in the creation start request received in Act 201. The processor 11 acquires the catalog of the shopping list from the list table T2, for example. The catalog of the shopping list includes the list ID and the creation date and time of each shopping list. Then, the processor 11 instructs the communication interface 15 to transmit the generated creation permission response to the user terminal 40. Upon receiving the instruction, the communication interface 15 transmits the creation permission response to the user terminal 40. The transmitted creation permission response is received by the communication interface 45 of the user terminal 40.

Meanwhile, in Act 7 in FIG. 10, the processor 41 stands by until the creation permission response is received by the communication interface 45 of the user terminal 40. If the creation permission response is received, the processor 41 determines Yes in Act 7 and proceeds to the process in Act 8.

In Act 8, the processor 41 generates an image corresponding to a first list catalog screen. Then, the processor 41 instructs the display device 47 to display the generated image. Upon receiving the instruction, the display device 47 displays the first list catalog screen.

The first list catalog screen includes, for example, a new creation button and a catalog of the shopping list contained in the creation permission response received in Act 7. The new creation button is operated by the operator of the user terminal 40 when instructing the creation of a new shopping list.

In Act 9, the processor 41 determines whether or not an operation for instructing the creation of the new shopping list is performed. Specifically, the processor 41 determines whether or not a predetermined operation such as operating the new creation button is performed. If the operation for instructing the creation of the new shopping list is not performed, the processor 41 determines No in Act 9 and proceeds to the process in Act 10.

In Act 10, the processor 41 determines whether or not a shopping list is selected from the catalog of the shopping lists contained in the first list catalog screen. If the shopping list is not selected, the processor 41 determines No in Act 10 and returns to the process in Act 9. Thus, the processor 41 repeats the processes in Act 9 and Act 10 until the operation for instructing creation of the new shopping list is performed or the shopping list is selected.

If the operator of the user terminal 40 wants to create a new shopping list, the operator operates the new creation button.

If the operation for instructing the creation of the new shopping list is performed in the standby state in Act 9 and Act 10, the processor 41 determines Yes in Act 9 and proceeds to the process in Act 11.

In Act 11, the processor 41 generates a new creation request to request the support server 10 to create the new shopping list. The new creation request includes the member ID stored in the auxiliary storage device 44. Then, the processor 41 instructs the communication interface 45 to transmit the generated new creation request to the support server 10. Upon receiving the instruction, the communication interface 45 transmits the new creation request to the support server 10. The transmitted new creation request is received by the communication interface 15 of the support server 10. Further, the processor 41 newly creates the shopping list and stores it in the RAM 43 or the auxiliary storage device 44. In the shopping list, the purchase-planned commodity is not registered. Furthermore, the processor 41 stores a list ID of the newly created shopping list in the RAM 43 or the auxiliary storage device 44. The list ID is transmitted from the support server 10 as described later.

Meanwhile, in Act 205 in FIG. 17, the processor 11 of the support server 10 determines whether or not the list is acquired by the user terminal 40. If the list is not acquired, the processor 11 determines No in Act 205 and proceeds to the process in Act 206.

In Act 206, the processor 11 determines whether or not the new creation request is received by the communication interface 15. If the new creation request is not received, the processor 11 determines No in Act 206 and returns to the process in Act 205. Thus, the processor 11 repeats the processes in Act 205 and Act 206 until acquisition of the list is performed by the user terminal 40 or the new creation request is received by the communication interface 15.

If the new creation request is received in the standby state in Act 205 and Act 206, the processor 11 determines Yes in Act 206 and proceeds to the process in Act 207.

In Act 207, the processor 11 of the support server 10 creates a new shopping list. Specifically, the processor 11 adds a record to the list table T2. At this time, the processor 11 assigns a unique list ID to the newly created shopping list. The added record includes the list ID and the member ID contained in the new creation request received in Act 206. The processor 11 instructs the communication interface 15 to transmit the list ID to the user terminal 40. Upon receiving the instruction, the communication interface 15 transmits the list ID to the user terminal 40. The transmitted list ID is received by the communication interface 45 of the user terminal 40. The list ID is stored in the RAM 43 or the auxiliary storage device 44 as described above.

On the other hand, if the operator of the user terminal 40 wants to edit the stored shopping list, the operator selects a shopping list he/she wants to edit from the catalog of shopping list contained in the first list catalog screen. The operator of the user terminal 40 specifies a desired shopping list, for example, according to the creation date and time displayed on the first list catalog screen.

If the shopping list is selected in the standby state in Act 9 and Act 10 in FIG. 10, the processor 41 determines Yes in Act 10 and proceeds to the process in Act 12.

In Act 12, the processor 41 of the user terminal 40 acquires the shopping list selected in Act 10 from the support server 10. Then, the processor 41 stores the acquired shopping list in the RAM 43 or the auxiliary storage device 44. The processor 41 stores the list ID corresponding to the shopping list in the RAM 43 or the auxiliary storage device 44.

The list ID stored in the RAM 43 or the auxiliary storage device 44 in Act 11 or Act 12 is hereinafter referred to as “creation target list ID”.

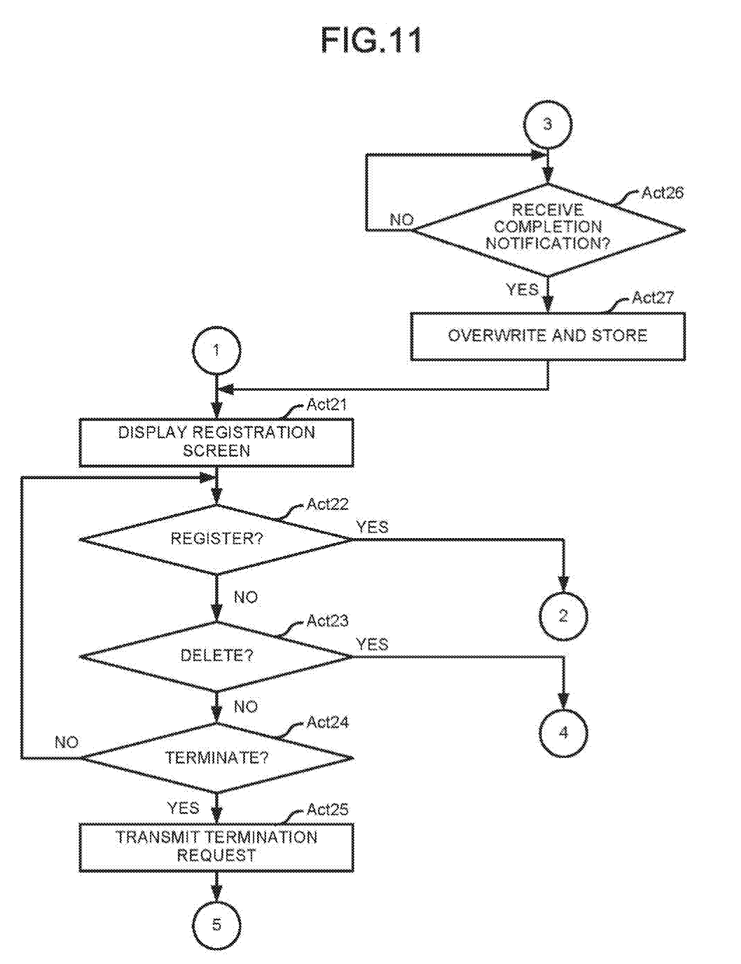

After the process in Act 11 or Act 12, the processor 41 proceeds to the process in Act 21 in FIG. 11.

In Act 21, the processor 41 generates an image corresponding to a registration screen. Then, the processor 41 instructs the display device 47 to display the generated image. Upon receiving the instruction, the display device 47 displays the registration screen.

As an example, the registration screen includes a catalog of the purchase-planned commodity, a registration button, a deletion button, and a termination button. The catalog of the purchase-planned commodity is a catalog of the purchase-planned commodity contained in the shopping list stored in the RAM 43 or the auxiliary storage device 44. The registration button is operated by the operator of the user terminal 40 when additionally registering the purchase-planned commodity in the shopping list. The deletion button is operated by the operator of the user terminal 40 when deleting the purchase-planned commodity registered in the shopping list. The termination button is operated by the operator of the user terminal 40 when terminating the editing of the shopping list.

In Act 22, the processor 41 determines whether or not an operation for instructing additional registration of the purchase-planned commodity is performed. Specifically, the processor 41 determines whether or not a predetermined operation such as operating the registration button is performed. If the operation for instructing the additional registration of the purchase-planned commodity is not performed, the processor 41 determines No in Act 22 and proceeds to the process in Act 23.

In Act 23, the processor 41 determines whether or not an operation for instructing deletion of the purchase-planned commodity is performed. Specifically, the processor 41 determines whether or not a predetermined operation such as operating the deletion button is performed. If the operation for instructing deletion of the purchase-planned commodity is not performed, the processor 41 determines No in Act 23 and proceeds to the process in Act 24.

In Act 24, the processor 41 determines whether or not an operation for instructing the termination of the editing of the shopping list is performed. Specifically, the processor 41 determines whether or not a predetermined operation such as operating the termination button is performed. If the operation for instructing the termination of the editing of the shopping list is not performed, the processor 41 determines No in Act 24 and returns to the process in Act 22. Thus, the processor 41 repeats the processes in Act 22 to Act 24 until the operation for instructing the additional registration of the purchase-planned commodity, the operation for instructing the deletion of the purchase-planned commodity, or the operation for instructing the termination of the editing of the shopping list is performed.

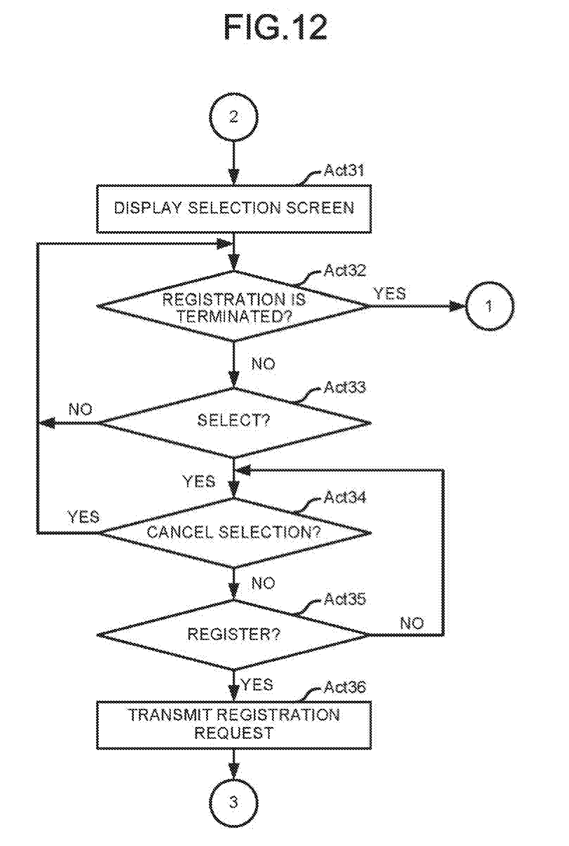

If the operation for instructing the additional registration of the purchase-planned commodity is performed in the standby state in Act 22 to Act 24, the processor 41 determines Yes in Act 22 and proceeds to the process in Act 31 in FIG. 12.

In Act 31, the processor 41 generates an image corresponding to an additional selection screen for selecting the purchase-planned commodity to be added. Then, the processor 41 instructs the display device 47 to display the generated image. Upon receiving the instruction, the display device 47 displays the additional selection screen.

The additional selection screen includes, for example, a catalog of the commodity, a registration termination button, and a registration button. The commodity contained in the catalog of the commodity is selected by an operation of selecting the commodity by the operator of the user terminal 40. An operation of canceling the selection of the commodity is performed by the operator of the user terminal 40, and thus the commodity being selected enters an unselected state. The registration termination button is operated by the operator of the user terminal 40 when terminating the additional registration of the purchase-planned commodity. The registration button is operated by the operator of the user terminal 40 when the commodity being selected is additionally registered as the purchase-planned commodity in the shopping list.

In Act 32, the processor 41 determines whether or not an operation for instructing the termination of the additional registration of the purchase-planned commodity is performed. Specifically, the processor 41 determines whether or not a predetermined operation such as operating the registration termination button is performed. If the operation for instructing the termination of the additional registration of the purchase-planned commodity is not performed, the processor 41 determines No in Act 32 and proceeds to the process in Act 33.

In Act 33, the processor 41 determines whether or not the commodity is in the selected state. If no commodity is selected, the processor 41 determines No in Act 33 and returns to the process in Act 32. In this way, the processor 41 repeats the processes in Act 32 and Act 33 until the operation for instructing the termination of the additional registration of the purchase-planned commodity is performed, or the commodity is selected.

If the operation for instructing the termination of the additional registration of the purchase-planned commodity is performed in the standby state in Act 32 and Act 33, the processor 41 determines Yes in Act 32 and returns to the process in Act 21 in FIG. 11. On the other hand, if the commodity is selected in the standby state in Act 32 and Act 33 in FIG. 12, the processor 41 determines Yes in Act 33 and proceeds to the process in Act 34.

In Act 34, the processor 41 determines whether or not the commodity being selected in the Act 33 enters the unselected state. If the commodity being selected does not enter the unselected state, the processor 41 determines No in Act 34 and proceeds to the process in Act 35.

In Act 35, the processor 41 determines whether or not the operation for instructing additional registration of the commodity being selected in the Act 33 in the shopping list is performed. Specifically, the processor 41 determines whether or not a predetermined operation such as operating the registration button is performed. If the operation for instructing the additional registration of the selected commodity in the shopping list is not performed, the processor 41 determines No in Act 35 and returns to the process in Act 34. Thus, the processor 41 repeats the processes in Act 34 and Act 35 until the commodity being selected enters the unselected state, or the operation for instructing the additional registration of the selected commodity in the shopping list is performed.

If the commodity being selected enters the unselected state in the standby state in Act 34 and Act 35, the processor 41 determines Yes in Act 34 and returns to the process in Act 32. On the other hand, if the operation for instructing the additional registration of the selected commodity in the shopping list is performed in the standby state in Act 34 and Act 35, the processor 41 determines Yes in Act 35 and proceeds to the process in Act 36.

In Act 36, the processor 41 generates a registration request for instructing the support server 10 to additionally register the selected commodity in the shopping list. The registration request includes the creation target list ID and the commodity ID of the selected commodity. Then, the processor 41 instructs the communication interface 45 to transmit the generated registration request to the support server 10. Upon receiving the instruction, the communication interface 45 transmits the registration request to the support server 10. The transmitted registration request is received by the communication interface 15 of the support server 10. After the process in Act 36, the processor 41 proceeds to the process in Act 26 in FIG. 11.

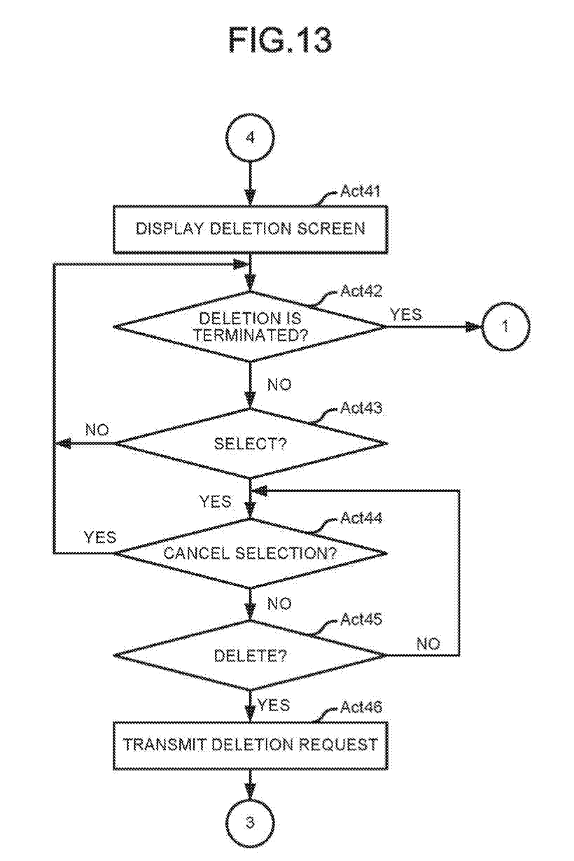

On the other hand, if the operation for instructing deletion of the purchase-planned commodity is performed in the standby state in Act 22 to Act 24, the processor 41 determines Yes in Act 23 and proceeds to the process in Act 41 in FIG. 13.

In Act 41, the processor 41 generates an image corresponding to a deletion screen for selecting the purchase-planned commodity to be deleted. Then, the processor 41 instructs the display device 47 to display the generated image. Upon receiving the instruction, the display device 47 displays the deletion screen.

The deletion screen includes, for example, a catalog of the purchase-planned commodity registered in the shopping list, a deletion termination button, and a deletion button. The purchase-planned commodity contained in the catalog of the purchase-planned commodity is selected by an operation of selecting the purchase-planned commodity by the operator of the user terminal 40. The selected purchased-planned commodity enters the unselected state by an operation of canceling the selection of the purchase-planned commodity by the operator of the user terminal 40. The deletion termination button is operated by the operator of the user terminal 40 when terminating the deletion of the purchase-planned commodity. The deletion button is operated by the operator of the user terminal 40 when the selected purchase-planned commodity is deleted from the shopping list.

In Act 42, the processor 41 determines whether or not an operation for instructing the termination of deletion of the purchase-planned commodity is performed. Specifically, the processor 41 determines whether or not a predetermined operation such as operating the deletion termination button is performed. If the operation for instructing the termination of deletion of the purchase-planned commodity is not performed, the processor 41 determines No in Act 42 and proceeds to the process in Act 43.

In Act 43, the processor 41 determines whether or not the commodity is selected. If the commodity is not selected, the processor 41 determines No in Act 43 and returns to the process in Act 42. Thus, the processor 41 repeats the processes in Act and Act 43 until the operation for instructing the termination of deletion of the purchase-planned commodity is performed or the purchase-planned commodity is selected.

If the operation for instructing the termination of deletion of the purchase-planned commodity is performed in the standby state in Act 42 and Act 43, the processor 41 determines Yes in Act 42 and returns to the process in Act 21 in FIG. 11. On the other hand, if the purchase-planned commodity is selected in the standby state in Act 42 and Act 43 in FIG. 12, the processor 41 determines Yes in Act 43 and proceeds to the process in Act 44.

In Act 44, the processor 41 determines whether or not the purchase-planned commodity selected in Act 43 enters the unselected state. If the selected purchase-planned commodity does not enter the unselected state, the processor 41 determines No in Act 44 and proceeds to the process in Act 45.

In Act 45, the processor 41 determines whether or not an operation for instructing deletion of the purchase-planned commodity selected in Act 43 from the shopping list is performed. Specifically, the processor 41 determines whether or not a predetermined operation such as operating the deletion button is performed. If the operation for instructing deletion of the selected purchase-planned commodity from the shopping list is not performed, the processor 41 determines No in Act 45 and returns to the process in Act 44. Thus, the processor 41 repeats the processes in Act 44 and Act 45 until the selected purchase-planned commodity enters the unselected state or the operation for instructing deletion of the selected purchase-planned commodity from the shopping list is performed.

If the selected purchase-planned commodity enters the unselected state in the standby state in Act 44 and Act 45, the processor 41 determines Yes in Act 44 and returns to the process in Act 42. On the other hand, if the operation for instructing the deletion of the selected purchase-planned commodity from the shopping list is performed in the standby state in Act 44 and Act 45, the processor 41 determines Yes in Act 45 and proceeds to the process in Act 46.

In Act 46, the processor 41 generates a deletion request to instruct the support server 10 to delete the selected purchase-planned commodity from the shopping list. The deletion request includes the creation target list ID and the purchase plan ID of the selected purchase-planned commodity. Then, the processor 41 instructs the communication interface 45 to transmit the generated deletion request to the support server 10. Upon receiving the instruction, the communication interface 45 transmits the deletion request to the support server 10. The transmitted deletion request is received by the communication interface 15 of the support server 10. After the process in Act 46, the processor 41 proceeds to the process in Act 26 in FIG. 11.

Meanwhile, in Act 208 in FIG. 17, the processor 11 of the support server 10 determines whether or not the registration request is received by the communication interface 15. If the registration request is not received by the communication interface 15, the processor 11 determines No in Act 208 and proceeds to the process in Act 209.

In Act 209, the processor 11 determines whether or not the deletion request is received by the communication interface 15. If the deletion request is not received by the communication interface 15, the processor 11 determines No in Act 209 and proceeds to the process in Act 210.

In Act 210, the processor 11 determines whether or not a termination request is received by the communication interface 15. The termination request is described later. If the termination request is not received by the communication interface 15, the processor 11 determines No in Act 210 and returns to the process in Act 208. Thus, the processor 11 repeats the processes in Act 208 to Act 210 until the registration request, the deletion request or the termination request is received by the communication interface 15.

If the registration request is received in the standby state in Act 208 to Act 210, the processor 11 determines Yes in Act 208 and proceeds to the process in Act 211.

In Act 211, the processor 11 additionally registers a commodity specified by the commodity ID contained in the registration request as the purchase-planned commodity in the shopping list specified by the creation target list ID contained in the registration request. Specifically, the processor 11 adds a record to the registration table T3. At this time, the processor 11 assigns the unique purchase plan ID to the purchase-planned commodity. The added record includes the purchase plan ID, the creation target list ID, and the commodity ID. An initial value of the purchase flag contained in the added record is False. The display order contained in the added record is, for example, the number of the purchase plan ID associated with the creation target list ID.

If the deletion request is received in the standby state in Act 208 to Act 210, the processor 11 determines Yes in Act 209 and proceeds to the process in Act 212.

In Act 212, the processor 11 deletes the purchase-planned commodity specified by the purchase plan ID contained in the deletion request from the shopping list specified by the creation target list ID contained in the deletion request. Specifically, the processor 11 deletes the record specified by the purchase plan ID from the registration table T3.

After the processes in Act 211 or Act 212, the processor 11 proceeds to the process in Act 213.

In Act 213, the processor 11 generates a first completion notification indicating that the registration or the deletion is completed. The first completion notification includes the shopping list specified by the creation target list ID. Then, the processor 11 instructs the communication interface 15 to transmit the generated first completion notification to the user terminal 40. Upon receiving the instruction, the communication interface 15 transmits the first completion notification to the user terminal 40. The transmitted first completion notification is received by the communication interface 45 of the user terminal 40. After the process in Act 213, the processor 11 returns to the process in Act 210.

Meanwhile, in Act 26 in FIG. 11, the processor 41 of the user terminal 40 stands by until the first completion notification is received by the communication interface 45. If the first completion notification is received, the processor 41 determines Yes in Act 26 and proceeds to the process in Act 27.

In Act 27, the processor 41 stores the shopping list contained in the first completion notification received in Act 26 in the RAM 43 or the auxiliary storage device 44. The processor 41 overwrites the shopping list already stored in the RAM 43 or the auxiliary storage device 44 with the new shopping list and stores the new shopping list. After the process in Act 27, the processor 41 returns to the process in Act 21.

If the operation for instructing the termination of the editing of the shopping list is performed in the standby state in Act 22 to Act 24, the processor 41 determines Yes in Act 24 and proceeds to the process in Act 25.

In Act 25, the processor 41 instructs the communication interface 45 to transmit a termination request for terminating the editing of the shopping list to the support server 10. Upon receiving the instruction, the communication interface 45 transmits the termination request to the support server 10. The transmitted termination request is received by the communication interface 15 of the support server 10.

Meanwhile, if the termination request is received in the standby state in Act 208 to Act 210 in FIG. 17, the processor 11 of the support server 10 determines Yes in Act 210 and returns to the process in Act 201.

Similarly, the operator of the user terminal 40 operates the shopping start button when the created shopping list is used for shopping.

If the operation for instructing the start of the shopping is performed in the standby state in Act 4 and Act 5 in FIG. 10, the processor 41 of the user terminal 40 determines Yes in Act 5 and proceeds to the process in Act 13.

In Act 13, the processor 41 generates the shopping start request for starting the shopping. The shopping start request includes the member ID stored in the RAM 43 or the auxiliary storage device 44. Then, the processor 41 instructs the communication interface 45 to transmit the generated shopping start request to the support server 10. Upon receiving the instruction, the communication interface 45 transmits the shopping start request to the support server 10. The transmitted shopping start request is received by the communication interface 15 of the support server 10.

Meanwhile, if the shopping start request is received in the standby state in Act 201 to Act 203 in FIG. 17, the processor 11 of the support server 10 determines Yes in Act 202 and proceeds to the process in Act 214.

In Act 214, the processor 11 generates a shopping permission response indicating the permission of the start of shopping which uses the shopping list. The shopping permission response includes a catalog of the shopping list associated with the member ID contained in the shopping start request received in Act 202. The processor 11 acquires the catalog of the shopping list from, for example, the list table T2. The catalog of the shopping list includes the list ID and the creation date and time of the shopping list. Then, the processor 11 instructs the communication interface 15 to transmit the generated shopping permission response to the user terminal 40. Upon receiving the instruction, the communication interface 15 transmits the shopping permission response to the user terminal 40. The transmitted shopping permission response is received by the communication interface 45 of the user terminal 40.

Meanwhile, in Act 14 in FIG. 10, the processor 41 of the user terminal 40 stands by until the shopping permission response is received by the communication interface 45. If the shopping permission response is received, the processor 41 determines Yes in Act 14 and proceeds to the process in Act 15.

In Act 15, the processor 41 generates an image corresponding to a second list catalog screen. Then, the processor 41 instructs the display device 47 to display the generated image. Upon receiving the instruction, the display device 47 displays the second list catalog screen.

The second list catalog screen includes, for example, a catalog of the shopping list contained in the shopping permission response received in Act 14.

The operator of the user terminal 40 selects the shopping list to be used for shopping from the stored shopping list displayed on the second list catalog screen. The operator of the user terminal 40 specifies a desired shopping list according to the creation date and time displayed on the second list catalog screen, for example.

In Act 17, the processor 41 of the user terminal 40 acquires the shopping list selected in Act 16 from the support server 10. Then, the processor 41 stores the acquired shopping list in the RAM 43 or the auxiliary storage device 44. The processor 41 stores the list ID corresponding to the shopping list in the RAM 43 or the auxiliary storage device 44. The list ID stored in the RAM 43 or the auxiliary storage device 44 in Act 17 is referred to as a “purchase target list ID”.

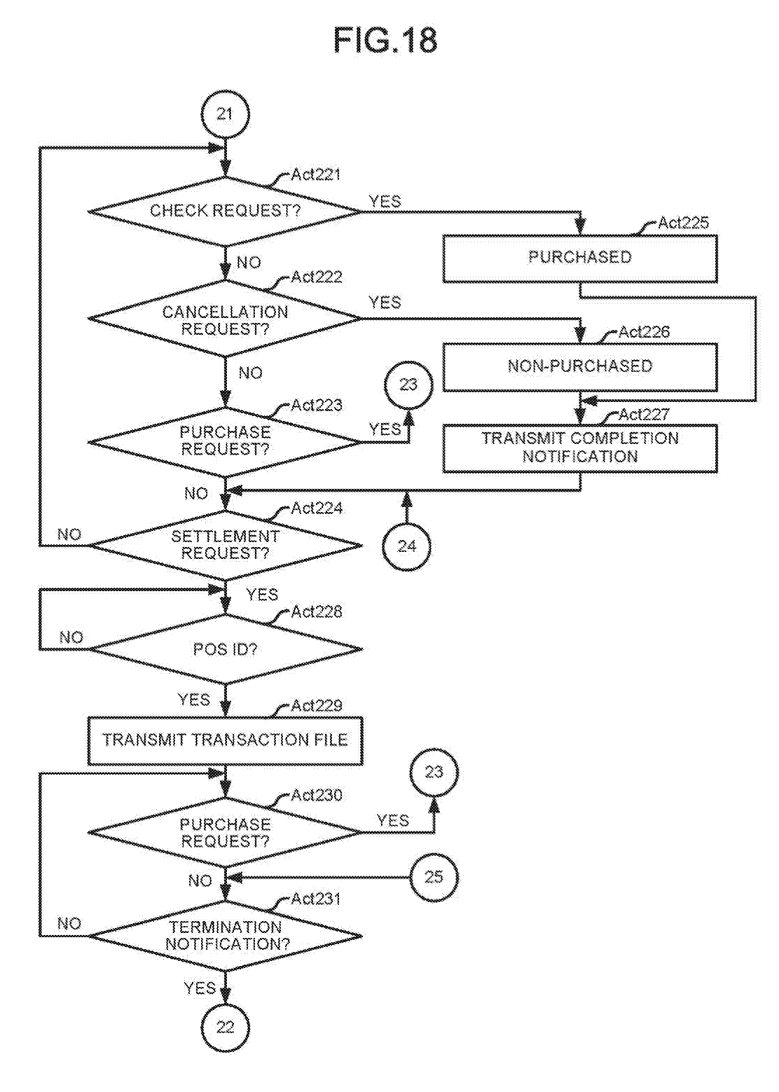

Meanwhile, in Act 215 in FIG. 17, the processor 11 of the support server 10 stands by until the list is acquired by the user terminal 40. If the list is acquired by the user terminal 40, the processor 11 determines Yes in Act 215 and proceeds to the process in Act 221 in FIG. 18.

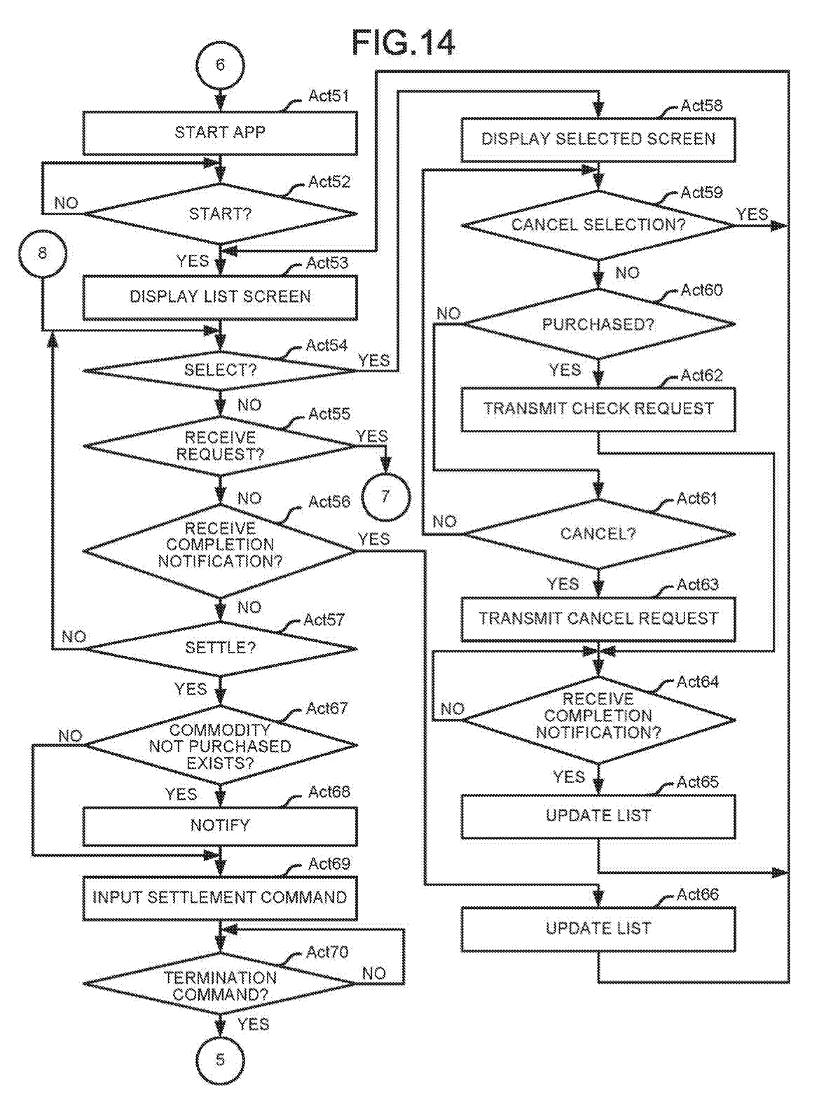

Meanwhile, the processor 41 of the user terminal 40 proceeds to the process in Act 51 in FIG. 14 after the process in Act 17 in FIG. 10.

In Act 51, the processor 41 activates the self-scanning app. In response to activation of the self-scanning app, the processor 41 starts the process shown in FIG. 16. The processor 41 performs the processes shown in FIG. 16 in parallel with the processes shown in FIG. 10 to FIG. 15. The self-scanning app activated by the process in Act 51 operates in cooperation with the list app.

In Act 101 in FIG. 16, the processor 41 determines whether or not the user terminal 40 logs into the self-scanning service. If the user terminal 40 logs into the self-scanning service, the processor 41 determines Yes in Act 101 and proceeds to the process in Act 103. On the other hand, if the user terminal 40 does not log into the self-scanning service, the processor 41 determines No in Act 101 and proceeds to the process in Act 102.

In Act 102, the processor 41 performs the login process such that the user terminal 40 logs into the self-scanning service. For the login process, well-known methods may be used. Through the login process, the RAM 43 or the auxiliary storage device 44 stores the member ID used for login. The support server 10 identifies that the user terminal 40 logs into the self-scanning service with the member ID. The operator of the user terminal 40 designates a retail store in which the self-scanning service is used at the time of the login, for example. Thus, the support server 10 identifies the retail store in which the self-scanning service is used by the user terminal 40. Hereinafter, at the time of communicating with the POS server 20, the support server 10 communicates with the POS server 20 corresponding to the retail store.

In Act 103, the processor 41 starts the camera 48.

In Act 104, the processor 41 determines whether or not the barcode attached to commodity is read by the camera 48. If the barcode attached to the commodity is not read by the camera 48, the processor 41 determines No in Act 104 and proceeds to the process in Act 105.

In Act 105, the processor 41 determines whether or not a settlement command is input to the self-scanning app. If no settlement command is input to the self-scanning app, the processor 41 determines No in Act 105 and returns to the process in Act 104. Thus, the processor 41 repeats the processes in Act 104 and Act 105 until the barcode attached to the commodity is read by the camera 48 or the settlement command is input to the self-scanning app.

Meanwhile, in Act 52 in FIG. 14, the processor 41 stands by until the self-scanning app is started. If the self-scanning app is started, the processor 41 determines Yes in Act 52 and proceeds to the process in Act 53 in FIG. 14.

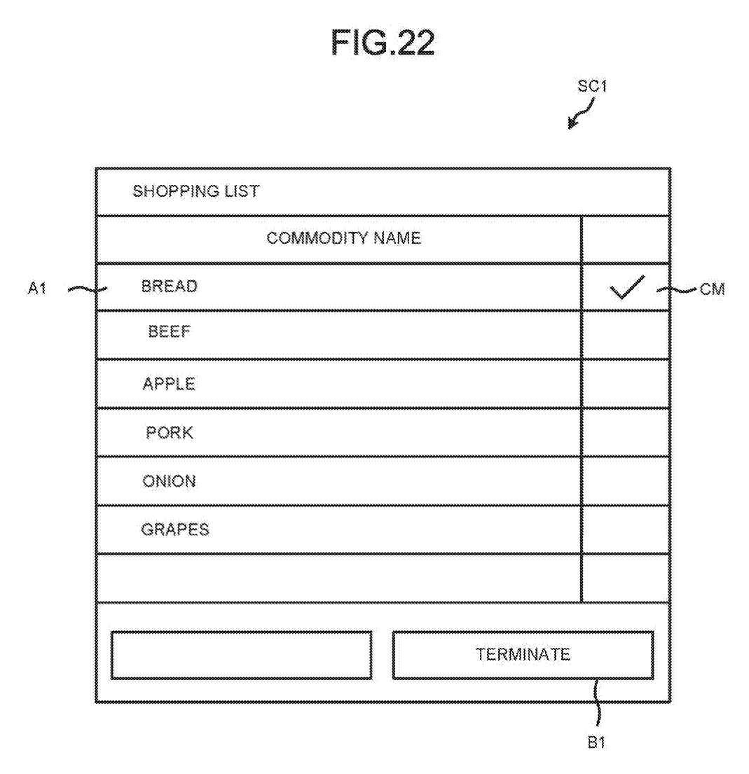

In Act 53, the processor 41 generates an image corresponding to the list screen SC1 as shown in FIG. 22. Then, the processor 41 instructs the display device 47 to display the generated image. Upon receiving the instruction, the display device 47 displays the list screen SC1.

FIG. 22 is a diagram illustrating an example of the list screen SC1. The list screen SC1 includes an area A1 in which a catalog of the purchase-planned commodities contained in the shopping list stored in the RAM 43 or the auxiliary storage device 44 is displayed, and a termination button B1. Here, the purchase-planned commodity displayed in the area A1 is displayed in an order depending on a value of the display order thereof shown in the registration table T3, i.e., the purchase-planned commodity is shown first as the value of the display order is large. In the area A1, for example, bread, beef, apple, pork, onion, and grapes are displayed in this order in FIG. 22. A check mark or the like is displayed in an area in which the purchase-planned commodity of which a value of the purchase flag is True is displayed. The area in which the purchase-planned commodity contained in the area A1 is displayed is a button. The button is operated by the operator of the user terminal 40 if the operator selects the purchase-planned commodity displayed in each button. If the button is operated, the corresponding purchase-planned commodity is selected. The termination button B1 is operated by the operator of the user terminal 40 when terminating shopping using the shopping list.

In Act 54, the processor 41 determines whether or not an operation for selecting the purchase-planned commodity displayed on the list screen SC1 is performed. If the operation for selecting the purchase-planned commodity is not performed, the processor 41 determines No in Act 54 and proceeds to the process in Act 55.

In Act 55, the processor 41 determines whether or not a request such as a confirmation request or a selection request is received by the communication interface 45. If the request is not received, the processor 41 determines No in Act 55 and proceeds to the process in Act 56. The confirmation request and the selection request are described later.

In Act 56, the processor 41 determines whether or not a third completion notification is received by the communication interface 45. If the third completion notification is not received, the processor 41 determines No in Act 56 and proceeds to the process in Act 57. The third completion notification is described later.

In Act 57, the processor 41 determines whether or not an operation for terminating the shopping and performing the settlement is performed. Specifically, the processor 41 determines whether or not a predetermined operation such as operating a settlement button B3 is performed. If the operation for terminating the shopping and performing the settlement is not performed, the processor 41 determines No in Act 57 and returns to the process in Act 54. Thus, the processor 41 repeats the processes in Act 54 to Act 57 until the operation for selecting the purchase-planned commodity is performed, the request or the third completion notification is received, or the operation for terminating the shopping and performing the settlement is performed.

The operator of the user terminal 40 takes the purchase-planned commodity from a display place such as a display shelf, and puts it in a basket or the like. At this time, for example, the operator of the user terminal 40 performs the following operation (1) or (2) so as to set the purchase-planned commodity corresponding to the commodity from the purchase-planned commodities contained in the shopping list to a state (purchased state) showing that the purchase-planned commodity has been taken or purchased. The following explanation is made assuming that the operator of the user terminal 40 takes “apple” from a display shelf or the like.

(1) Operation A

The operator of the user terminal 40 selects the purchase-planned commodity corresponding to the commodity taken from the display place from the purchase-planned commodities displayed on the list screen SC1. Specifically, the operator of the user terminal 40 selects “apple” by operating the button corresponding to “apple” from the purchase-planned commodities displayed on the list screen SC1.

(2) Operation B

The operator of the user terminal 40 uses the camera 48 to read the barcode attached to the commodity taken from the display place. Specifically, the operator of the user terminal 40 uses the camera 48 to read the barcode attached to the apple.

If the operation for selecting the purchase-planned commodity is performed in the standby state in Act 54 to Act 57, the processor 41 determines Yes in Act 54 and proceeds to the process in Act 58. In Act 58, the processor 41 generates an image corresponding to a selection completion screen. Then, the processor 41 instructs the display device 47 to display the generated image. Upon receiving the instruction, the display device 47 displays the selection completion screen.

The selection completion screen includes an area A2. For example, the area A2 is displayed on the list screen SC1 in a pop-up manner. The area A2 includes a character string S21, a check button B21, and a cancellation button B22. The character string S21 includes a character string for inquiring whether or not the selected purchase-planned commodity is taken from the display place, or a character string for inquiring whether or not the purchase-planned commodity is purchased. The character string S21 is, for example, “Do you put “apple” in your basket?”. The check button B21 is operated by the operator of the user terminal 40 when the purchase-planned commodity indicated in the character string S21 is purchased. As an example, the processor 41 displays a check mark on the side of the purchase-planned commodity to set the purchase-planned commodity to a purchased state. Alternatively, for example, the processor 41 changes a color of a part or all of the area in which the purchase-planned commodity is displayed to set the purchase-planned commodity to the purchased state. The cancellation button B22 is operated by the operator of the user terminal 40 when canceling the selection of the purchase-planned commodity being selected because the commodity indicated by the character string S21 has not been taken from the display place. If the cancellation button B22 is operated, the selection of the purchase-planned commodity being selected is canceled. The state of the purchase-planned commodity that is not purchased is referred to as “non-purchased state”. The purchase-planned commodity in the non-purchased state is in a state in which the purchase-planned commodity has not been taken or not purchased yet.

FIG. 21 shows a selection completion screen SC2 in the case in which the commodity in the non-purchased state is selected. The selection completion screen when the purchased state is selected includes a character string S22 instead of the character string S21 and a cancellation button B23 instead of the check button B21. The character string S22 includes a character string for inquiring whether to put the purchase-planned commodity being selected back to the display place or a character string for inquiring whether the purchase-planned commodity can be set in the non-purchased state. The cancel button B23 is operated by the operator of the user terminal 40 when the purchase-planned commodity indicated in the character string S22 is set in the non-purchased state.

In Act 59, the processor 41 determines whether or not an operation for canceling the selection of the purchase-planned commodity being selected is performed. Specifically, the processor 41 determines whether or not a predetermined operation such as operating the cancellation button B22 is performed. If the operation for canceling the selection of the purchase-planned commodity being selected is not performed, the processor 41 determines No in Act 59 and proceeds to the process in Act 60.

In Act 60, the processor 41 determines whether or not an operation of setting the purchase-planned commodity to the purchased state is performed. Specifically, the processor 41 determines whether or not a predetermined operation such as operating the check button B21 is performed. If the operation for setting the purchase-planned commodity to the purchased state is not performed, the processor 41 determines No in Act 60 and proceeds to the process in Act 61.

In Act 61, the processor 41 determines whether or not an operation for setting the purchase-planned commodity to a non-purchased state is performed. Specifically, the processor 41 determines whether or not a predetermined operation such as operating the cancel button B23 is performed. If the operation for setting the purchase-planned commodity to the non-purchased state is not performed, the processor 41 determines No in Act 61 and returns to the process in Act 59. Thus, the processor 41 repeats the processes in Act 59 to Act 61 until the operation for canceling the selection of the purchase-planned commodity being selected, the operation for setting the purchase-planned commodity to the purchased state, or the operation for setting the purchase-planned commodity to the non-purchased state is performed.

If an operation to cancel the selection of the purchase-planned commodity in the selected state is performed in the standby state in Act 59 to Act 61, the processor 41 determines Yes in Act 59 and returns to the process in Act 53.

On the other hand, if the operation for setting the purchase-planned commodity to the purchased state is performed in the standby state in Act 59 to Act 61, the processor 41 determines Yes in Act 60 and proceeds to the process in Act 62.

In Act 62, the processor 41 generates a check request for instructing to set the purchase-planned commodity to a purchased state. The check request includes the purchase target list ID, the purchase plan ID of the purchase-planned commodity being selected, and the member ID stored in the RAM 43 or the auxiliary storage device 44. Then, the processor 41 instructs the communication interface 45 to transmit the generated check request to the support server 10. Upon receiving the instruction, the communication interface 45 transmits the check request to the support server 10. The transmitted check request is received by the communication interface 15 of the support server 10.

Meanwhile, in Act 221 in FIG. 18, the processor 11 of the support server 10 determines whether or not the check request is received by the communication interface 15. If the check request is not received by the communication interface 15, the processor 11 determines No in Act 221 and proceeds to the process in Act 222.

In Act 222, the processor 11 determines whether or not a cancellation request is received by the communication interface 15. The cancellation request is described later. If the cancellation request is not received by the communication interface 15, the processor 11 determines No in Act 222 and proceeds to the process in Act 223.

In Act 223, the processor 11 determines whether or not a purchase request is received by the communication interface 15. The purchase request is described later. If the purchase request is not received by the communication interface 15, the processor 11 determines No in Act 223 and proceeds to the process in Act 224.

In Act 224, the processor 11 determines whether or not a settlement request is received by the communication interface 15. The settlement request is described later. If the settlement request is not received by the communication interface 15, the processor 11 determines No in Act 224 and returns to the process in Act 221. Thus, the processor 11 repeats the processes in Act 221 to Act 224 until the check request, the cancellation request, the purchase request or the settlement request is received.

If the check request is received in the standby state in Act 221 to Act 224, the processor 11 determines Yes in Act 221 and proceeds to the process in Act 225.

In Act 225, in order to set the purchase-planned commodity specified by the purchase plan ID contained in the check request received in Act 221 to the purchased state, the processor 11 sets the value of the purchase flag associated with the purchase plan ID in the registration table T3 to True. The processor 11 substitutes the current date and time into the purchase date and time associated with the purchase plan ID in the registration table T3.

If the operation for setting the purchase-planned commodity to the non-purchased state is performed in the standby state in Act 59 to Act 61 in FIG. 14, the processor 41 of the user terminal 40 determines Yes in Act 61 and proceeds to the process in Act 63.

In Act 63, the processor 41 generates the cancellation request for instructing to set the purchase-planned commodity to the non-purchased state. The cancellation request includes the purchase target list ID, the purchase plan ID of the purchase-planned commodity being selected, and the member ID stored in the RAM 43 or the auxiliary storage device 44. Then, the processor 41 instructs the communication interface 45 to transmit the generated cancellation request to the support server 10. Upon receiving the instruction, the communication interface 45 transmits the cancellation request to the support server 10. The transmitted cancellation request is received by the communication interface 15 of the support server 10.

Meanwhile, if the cancellation request is received in the standby state in Act 221 to Act 224 in FIG. 18, the processor 11 determines Yes in Act 222 and proceeds to the process in Act 226.

In Act 226, the processor 11 sets the value of the purchase flag associated with the purchase plan ID in the registration table T3 to False so as to set the purchase-planned commodity identified by the purchase plan ID contained in the cancellation request received in the Act 222 to the non-purchased state.

After the process in Act 225 or Act 226, the processor 11 proceeds to the process in Act 227.

In Act 227, the processor 11 generates a second completion notification indicating the completion of setting the purchase-planned commodity identified by the purchase plan ID contained in the check request or the cancellation request received in the Act 221 or Act 222 to the purchased state or the non-purchased state. The second completion notification includes the shopping list specified by the purchase target list ID contained in the check request or the cancellation request received in Act 221 or Act 222. Then, the processor 11 instructs the communication interface 15 to transmit the generated second completion notification to the user terminal 40. Upon receiving the instruction, the communication interface 15 transmits the second completion notification to the user terminal 40. The transmitted second completion notification is received by the communication interface 45 of the user terminal 40.

After the process in Act 227, the processor 11 returns to the process in Act 224.

Meanwhile, the processor 41 of the user terminal 40 proceeds to the process in Act 64 after the process in Act 62 or Act 63 in FIG. 14.

In Act 64, the processor 41 stands by until the second completion notification is received by the communication interface 45. If the second completion notification is received, the processor 41 determines Yes in Act 64 and proceeds to the process in Act 65.

In Act 65, the processor 41 stores the shopping list contained in the second completion notification received in Act 64 in the RAM 43 or the auxiliary storage device 44. The processor 41 overwrites the shopping list already stored in the RAM 43 or the auxiliary storage device 44 with the new shopping list and stores the new shopping list. After the process in Act 65, the processor 41 returns to the process in Act 53. The list screen SC1 displayed in the process in Act 53 when returning from. Act 65 to Act 53 is based on the new shopping list written through the process in Act 65.

Meanwhile, if the barcode attached to the commodity is read by the cameras 48 in the standby state in Act 104 and Act 105 in FIG. 16, the processor 41 determines Yes in Act 104 and proceeds to the process in Act 106.

In Act 106, the processor 41 generates the purchase request for instructing to perform the purchase registration on the barcode read in Act 104. The purchase request includes the purchase target list ID and the commodity ID recorded in the barcode. Then, the processor 41 instructs the communication interface 45 to transmit the generated purchase request to the support server 10. Upon receiving the instruction, the communication interface 45 transmits the purchase request to the support server 10. The transmitted purchase request is received by the communication interface 15 of the support server 10.

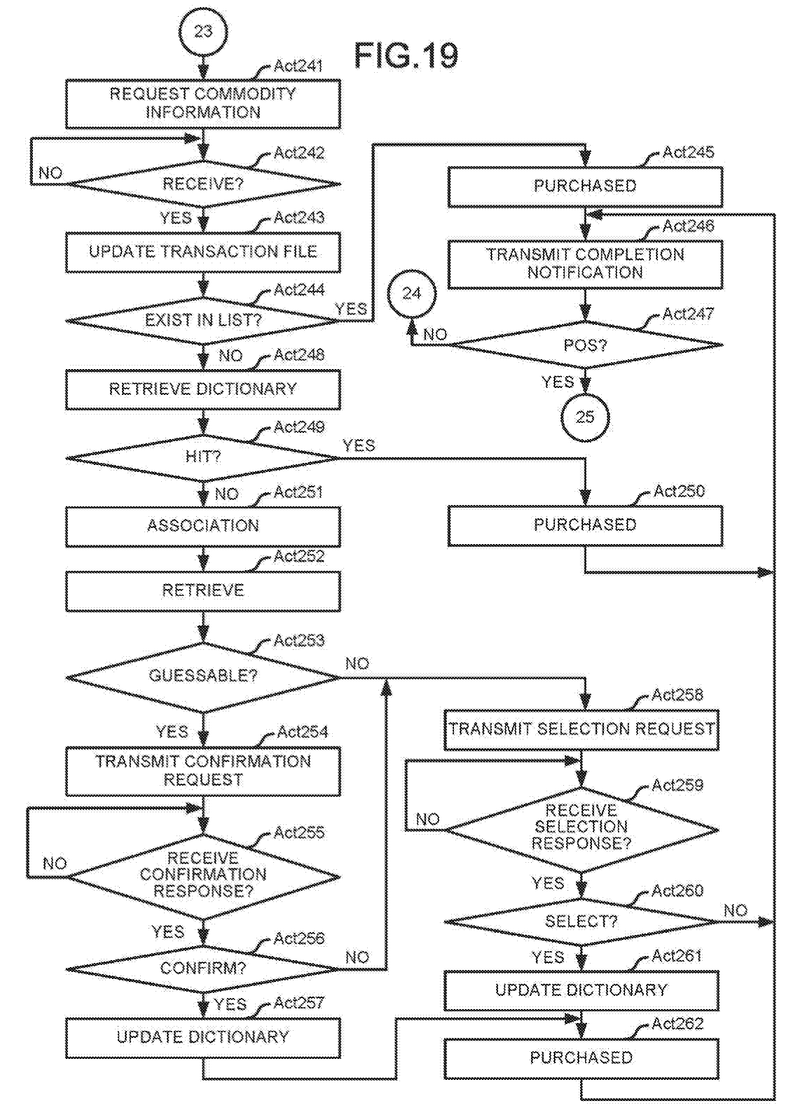

Meanwhile, if the purchase request is received in the standby state in Act 221 to Act 224 in FIG. 18, the processor 11 of the support server 10 determines Yes in Act 223 and proceeds to the process in Act 241 in FIG. 19. The commodity ID contained in the purchase request received in Act 223 or Act 230 is hereinafter referred to as a “registration target ID”.

In Act 241, the processor 11 generates a commodity information request to acquire the information of the commodity specified by the registration target ID. The commodity information request includes the commodity ID. Then, the processor 11 instructs the communication interface 15 to transmit the generated commodity information request to the POS server 20. Upon receiving the instruction, the communication interface 15 transmits the commodity information request to the POS server 20. The transmitted commodity information request is received by the communication interface 25 of the POS server 20.

Meanwhile, if the commodity information request is received, the POS server 20 refers to the commodity DB 241 to acquire the commodity information relating to the commodity specified by the commodity ID contained in the commodity information request. Then, the POS server 20 transmits the commodity information to the support server 10.

Meanwhile, in Act 242 in FIG. 19, the processor 11 of the support server 10 stands by until the commodity information is received by the communication interface 15. If the commodity information is received, the processor 11 determines Yes in Act 242 and proceeds to the process in Act 243. The following explanation is made assuming that the commodity name of the commodity information received in Act 242 is “Shinano Gold”. “Shinano Gold” is a kind of apple.

In Act 243, if a transaction file is not created, the processor 11 creates the transaction file. The processor 11 stores the transaction file in the auxiliary storage device 14 in association with the purchase target list ID contained in the purchase request. The transaction file includes member information including the member ID, the commodity list which is a catalog of commodities registered as purchased commodities, and the purchase target list ID. Then, the processor 11 updates the transaction file based on the commodity information received in Act 242. Specifically, the processor 11 registers the commodity specified by the commodity ID in the commodity list contained in the transaction file based on the registration target ID and the commodity information received in Act 242.

In Act 244, the processor 11 determines whether or not the purchase-planned commodity having the same name as the commodity specified by the registration target ID is contained in the shopping list specified by the purchase target list ID. For example, if the commodity specified by the registration target ID is “Shinano Gold”, the processor 11 refers to the list DB 142 to determine whether or not the purchase-planned commodity with the name “Shinano Gold” is contained in the shopping list specified by the purchase target list ID. If the purchase-planned commodity having the same name as the commodity specified by the registration target ID is contained in the shopping list specified by the purchase target list ID, the processor 11 determines Yes in Act 244 and proceeds to the process in Act 245. Even if the name “apple” is contained in the shopping list, since “Shinano Gold” and “apple” are not the same name, the processor 11 does not determine Yes in Act 244.

In Act 245, the processor 11 sets the value of the purchase flag associated with the purchase plan ID corresponding to the purchase-planned commodity in the registration table T3 to True so as to set the purchase-planned commodity that is the same as the commodity specified by the registration target ID to the purchased state.

In Act 246, the processor 11 generates a third completion notification indicating that the commodity specified by the registration target ID is registered in the transaction file. The third completion notification includes the shopping list specified by the purchase target list ID contained in the purchase request. Then, the processor 11 instructs the communication interface 15 to transmit the generated third completion notification to a transmission source of the purchase request. Upon receiving the instruction, the communication interface 15 transmits the third completion notification to the user terminal 40, for example. The third completion notification transmitted to the user terminal 40 is received by the communication interface 45.

Meanwhile, in Act 107 in FIG. 16, the processor 41 of the user terminal 40 stands by until the second completion notification or the third completion notification is received by the communication interface 45. If the second completion notification or the third completion notification is received, the processor 41 determines Yes in Act 107 and returns to the process in Act 104.

If the second completion notification or the third completion notification is received in the standby state in Act 54 to Act 57 in FIG. 14, the processor 41 determines Yes in Act 56 and proceeds to the process in Act 66.

In Act 66, the processor 41 stores the shopping list contained in the third completion notification received in Act 56 in the RAM 43 or the auxiliary storage device 44. The processor 41 overwrites the shopping list already stored in the RAM 43 or the auxiliary storage device 44 with the new shopping list and stores the new shopping list. After the process in Act 66, the processor 41 returns to the process in Act 53.

Meanwhile, in Act 247 in FIG. 19, the processor 11 of the support server 10 determines whether or not the transmission source of the purchase request is the POS terminal 50. If the transmission source of the purchase request is not the POS terminal 50, the processor 11 determines No in Act 247 and returns to the process in Act 224 in FIG. 18.

If the purchase-planned commodity having the same name as the commodity specified by the registration target ID is not contained in the shopping list specified by the purchase target list ID, the processor 11 determines No in Act 244 and proceeds to the process in Act 248.

In Act 248, the processor 11 uses the linkage dictionary to retrieve the alias of the commodity name specified by the registration target ID which is the same as the name of any of the purchase-planned commodities contained in the shopping list specified by the purchase target list ID. Specifically, from the dictionary table T4, the processor 11 retrieves a record in which the commodity name is specified by the registration target ID and the alias is the same as the name of any of the purchase-planned commodities contained in the shopping list. Alternatively, the processor 11 retrieves the dictionary table T4 for a record in which the commodity ID is the registration target ID and the alias is the same as the name of any of the purchase-planned commodities contained in the shopping list. If such a record is retrieved, the processor 11 stores the purchase plan ID of the purchase-planned commodity with the same name as the alias in the record in the RAM 13.

For example, if the commodity name specified by the registration target ID is “Shinano Gold” and the commodity names of the commodities contained in the shopping list are “bread”, “beef”, “apple”, . . . , the processor 11 operates as follows. Specifically, the processor 11 retrieves the dictionary table T4 for a record in which the commodity ID is the registration target ID or a record in which the commodity name is “Shinano Gold”, and extracts the record satisfying the condition. Then, the processor 11 retrieves the extracted records for a record in which the alias matches any one of commodity names “bread”, “beef”, “apple”, etc. of the commodities contained in the shopping list. Therefore, for example, if a record in which the commodity name is “Shinano Gold” and the alias is “apple” is present in the dictionary table T4, the processor 11 finds out the record.

In Act 249, the processor 11 determines whether or not the record satisfying the condition is found out through the process in Act 248. If the processor 11 finds out the record satisfying the condition through the process in Act 248, the processor 11 determines Yes in Act 249 and proceeds to the process in Act 250.

In Act 250, in order to set the purchase-planned commodity specified by the purchase plan ID stored in Act 248 to the purchased state, the processor 11 sets the value of the purchase flag associated with the purchase plan ID stored in Act 248 in the registration table T3 to True. After the process in Act 250, the processor 11 proceeds to the process in Act 246.

On the other hand, if the record satisfying the condition is not found out through the process in Act 248, the processor 11 determines No in Act 249 and proceeds to the process in Act 251. For example, if “Shinano Gold” and “apple” are not associated with each other according to the dictionary table T4, the processor 11 determines No in Act 249.

In Act 251, the processor 11 associates the registration target ID with the purchase target list ID. Specifically, the processor 11 adds the record in which the commodity ID is the registration target ID and the list ID is the purchase target list ID in the association table T5.

In Act 252, the processor 11 performs retrieval for specifying the alias of the commodity specified by the registration target ID. First, the processor 11 extracts a record in which the commodity ID is the registration target ID from the association table T5. Furthermore, the processor 11 refers to the registration table T3 to extract the name associated with the shopping list (hereinafter, referred to as an “extraction target list”) specified by the shopping list ID contained in the extracted record. Furthermore, the processor 11 counts the quantity for each extracted name. For example, if there are n purchase-planned commodities each having the name “apple” in the extraction target list, the count corresponding to the “apple” is n. Then, the processor 11 decides a name corresponding to the largest count as alias candidate of the commodity specified by the registration target ID among the names after the name associated with the registration target ID as the alias according to the dictionary table T4 is excluded. The alias candidate is an example of a first name. The commodity name of the commodity specified by the registration target ID is an example of a second name.

In Act 253, the processor 11 determines whether an alias candidate (hereinafter, referred to as a “target candidate”) that is highly likely to be an alias of the commodity specified by the registration target ID is found out or not. In other words, the processor 11 determines that the target candidate is not found out if the alias candidate is not found out through the process in Act 252. Then, if the alias candidate is found out through the process in Act 252, the processor 11 determines that the target candidate is found out if the condition is satisfied. On the other hand, the processor 11 determines that the target candidate is not found out if the condition is not satisfied. As examples of such conditions, the following three types (A) to (C) are shown. The target candidate is an example of the first name.

(A) Condition A

A value of the count n is greater than or equal to a predetermined threshold value. The threshold value is determined, for example, by a designer or an administrator of the support system 1.

(B) Condition B

(the number of extraction target lists)/(the number of shopping lists contained in the list DB 142) is equal to or greater than a predetermined threshold value. The threshold value is determined, for example, by the designer or administrator of the support system 1.

(C) Condition C

(the value of the count n)/(the number of extraction target lists) is equal to or greater than a predetermined threshold value. The threshold value is determined, for example, by the designer or administrator of the support system 1.

If the target candidate is found out, the processor 11 determines Yes in Act 253 and proceeds to the process in Act 254.

In Act 254, the processor 11 generates the confirmation request to enable the user of the shopping support service to confirm that the target candidate is an alias of the commodity specified by the registration target ID. The confirmation request includes the target candidate and the commodity name specified by the registration target ID. For example, the confirmation request includes the “apple” as the target candidate and the “Shinano Gold” as the commodity name. Then, the processor 11 instructs the communication interface 15 to transmit the generated confirmation request to the transmission source of the purchase request. Upon receiving the instruction, the communication interface 15 transmits the confirmation request to the user terminal 40, for example. The transmitted confirmation request is received by the communication interface 45 of the user terminal 40.

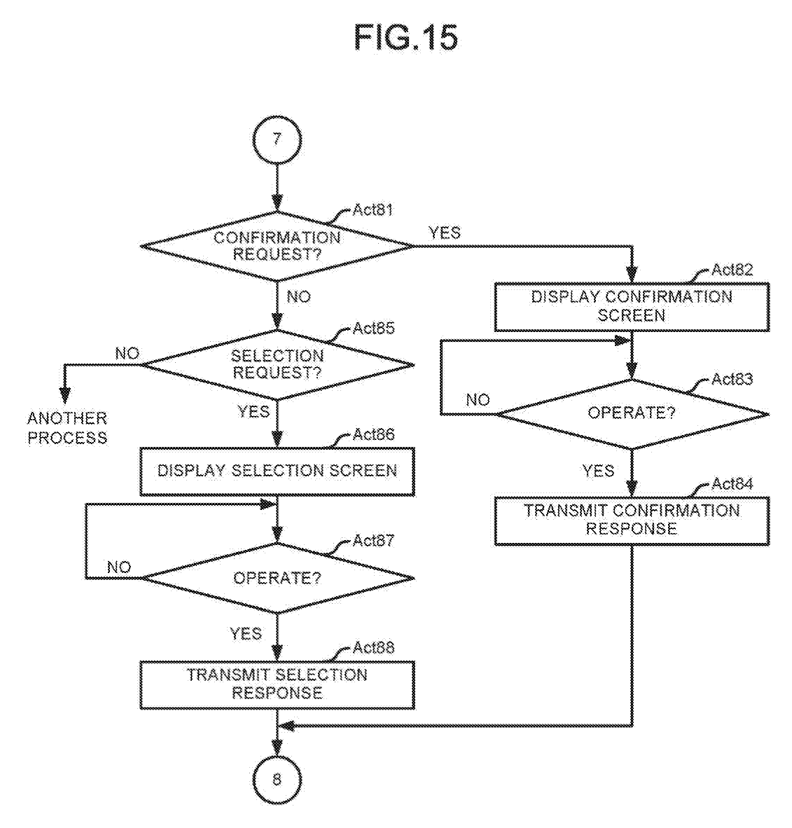

Meanwhile, if the request such as the confirmation request is received in the standby state in Act 54 to Act 57 in FIG. 14, the processor 41 of the user terminal 40 determines Yes in Act 55 and proceeds to the process in Act 81 in FIG. 15.

In Act 81, the processor 41 determines whether or not the request received in Act 54 is the confirmation request. If the request received in Act 54 is the confirmation request, the processor 41 determines Yes in Act 81 and proceeds to the process in Act 82.

In Act 82, the processor 41 generates an image corresponding to the first confirmation screen. Then, the processor 41 instructs the display device 47 to display the generated image. Upon receiving the instruction, the display device 47 displays the first confirmation screen.

The first confirmation screen is used for inquiring the operator of the user terminal 40 about whether or not the target candidate contained in the confirmation request is exactly the alias of the commodity name contained in the confirmation request. The first confirmation screen includes, for example, a character string S31, an affirmation button B31, and a denial button B32. The character string S31 is, for example, “is “Shinano Gold” is the “apple”?”. The affirmation button B31 is operated by the operator of the user terminal 40 when it is determined that the target candidate is the alias of the commodity name. The denial button B32 is operated by the operator of the user terminal 40 when it is determined that the target candidate is not the alias of the commodity name.

In Act 83, the processor 41 stands by until the confirmation button B31 or the denial button B32 displayed on the first confirmation screen is operated. If the confirmation button B31 or the denial button B32 is operated, the processor 41 determines Yes in Act 83 and proceeds to the process in Act 84.

In Act 84, the processor 41 generates a confirmation response indicating which one of the confirmation button B31 and the denial button B32 is operated. Then, the processor 41 instructs the communication interface 45 to transmit the generated confirmation response to the support server 10. Upon receiving the instruction, the communication interface 45 transmits the confirmation response to the support server 10. The transmitted confirmation response is received by the communication interface 15 of the support server 10. After the process in Act 84, the processor 41 returns to the process in Act 54 in FIG. 14.

Meanwhile, in Act 255 in FIG. 19, the processor 11 of the support server 10 stands by until the confirmation response is received by the communication interface 15. If the confirmation response is received, the processor 11 determines Yes in Act 255 and proceeds to the process in Act 256.

In Act 256, the processor 11 determines whether or not the confirmation response received in Act 255 indicates that the affirmation button B31 is operated. If the confirmation response received in Act 255 indicates that the confirmation button B31 is operated, the processor 11 determines Yes in Act 256 and proceeds to the process in Act 257.

In Act 257, the processor 11 updates the linkage dictionary. Specifically, the processor 11 adds a record to the dictionary table T4. In this record, the commodity ID is the registration target ID, the commodity name is specified by the registration target ID, and the alias is the target candidate. For example, in this record, the commodity name is “Shinano Gold” and the alias is “apple”. Accordingly, that the alias “Shinano Gold” is the “apple” is recorded in the linkage dictionary.

On the other hand, if the target candidate is not found out, the processor 11 determines No in Act 253 and proceeds to the process in Act 258. If the confirmation response received in Act 255 indicates that the denial button B32 is operated, the processor 11 determines No in Act 256 and proceeds to the process in Act 258.

In Act 258, the processor 11 generates a selection request for instructing the user of shopping support service to select which one of the purchase-planned commodities contained in the shopping list specified by the purchase target list ID corresponds to the alias of the commodity specified by the registration target ID. The selection request includes the commodity name specified by the registration target ID. For example, the confirmation request includes “Shinano Gold” as the commodity name. Then, the processor 11 instructs the communication interface 15 to transmit the generated selection request to the transmission source of the purchase request. Upon receiving the instruction, the communication interface 15 transmits the selection request to the user terminal 40, for example. The transmitted selection request is received by the communication interface 45 of the user terminal 40.

Meanwhile, if the request such as the selection request is received in the standby state in Act 54 to Act 57 in FIG. 14, the processor 41 of the user terminal 40 determines Yes in Act 55 and proceeds to the process in Act 81 in FIG. 15.

Then, if the request received in Act 55 is not the confirmation request, the processor 41 determines No in Act 81 and proceeds to the process in Act 85.

In Act 85, the processor 41 determines whether or not the request received in Act 55 is the selection request. If the request received in Act 55 is not the selection request, the processor 41 determines No in Act 85 and performs a process according to the received request. On the other hand, if the request received in Act 55 is the selection request, the processor 41 determines Yes in Act 85 and proceeds to the process in Act 86.

In Act 86, the processor 41 generates an image corresponding to the first selection screen. Then, the processor 41 instructs the display device 47 to display the generated image. Upon receiving the instruction, the display device 47 displays the first selection screen.

The first selection screen is used for inquiring the operator of the user terminal 40 about which one of purchase-planned commodities contained in the shopping list specified by the purchase target list ID, the commodity name contained in the selection request corresponds to. The first selection screen includes, for example, a character string S41, a plurality of selection buttons B41, and a denial button B42. The character string S41 is, for example, “which one of the purchase-planned commodities displayed below does the “Shinano Gold” correspond to?”. Each of the plurality of selection buttons B41 indicates a purchase-planned commodity contained in the shopping list stored in the RAM 43 or the auxiliary storage device 44. Therefore, for example, similarly to the area A1 on the list screen SC1, plural buttons B41 corresponding to bread, beef, apple, pork, onion, grapes and the like are respectively displayed. The denial button B42 operated by the operator of the user terminal 40 when the commodity name contained in the selection request does not correspond to any one of the purchase-planned commodities contained in the shopping list.

In Act 87, the processor 41 stands by until one of the plurality of selection buttons B41 and the denial button B42 is operated. If one of the plurality of selection buttons B41 and the denial button B42 is operated, the processor 41 determines Yes in Act 87 and proceeds to the process in Act 88.

In Act 88, the processor 41 generates a selection response indicating which one of the plurality of selection buttons B41 and the denial button B42 is operated. The selection response includes a name corresponding to the selection button B41 when the selection response indicates that the selection button B41 is operated. For example, the name is “apple”. Then, the processor 41 instructs the communication interface 45 to transmit the generated selection response to the support server 10. Upon receiving the instruction, the communication interface 45 transmits the selection response to the support server 10. The transmitted selection response is received by the communication interface 15 of the support server 10. After the process in Act 88, the processor 41 returns to the process in Act 54 in FIG. 14.

Meanwhile, in Act 259 in FIG. 19, the processor 11 of the support server 10 stands by until the selection response is received by the communication interface 45. If the selection response is received, the processor 11 determines Yes in Act 259 and proceeds to the process in Act 260.

In Act 260, the processor 11 determines whether or not the selection response received in Act 259 indicates that one of the select buttons B41 is operated. If the selection response received in Act 259 indicates that the denial button B42 is operated, the processor 11 determines No in Act 260 and proceeds to the process in Act 246. On the other hand, if the selection response received in Act 259 indicates that any one of the selection buttons B41 is operated, the processor 11 determines Yes in Act 260 and proceeds to the process in Act 261.

In Act 261, the processor 11 updates the linkage dictionary. Specifically, the processor 11 adds the record to the dictionary table T4. In the record, the commodity ID is the registration target ID, the commodity name is specified by the registration target ID, and the alias is the name contained in the selection response. For example, in this record, the commodity name is “Shinano Gold” and the alias is “apple”. Accordingly, that the alias “Shinano Gold” is the “apple” is recorded in the linkage dictionary.

After the process in Act 257 or Act 261, the processor 11 proceeds to the process in Act 262.

In Act 262, the processor 11 sets the value of the purchase flag associated with the purchase plan ID corresponding to the purchase-planned commodity in the registration table T3 to True so as to set the purchase-planned commodity corresponding to the commodity specified by the registration target ID to the purchased state. After the process in Act 262, the processor 11 proceeds to the process in Act 246.

If the operation for terminating the shopping and performing the settlement is performed in the standby state in Act 54 to Act 57 in FIG. 14, the processor 41 of the user terminal 40 determines Yes in Act 57 and proceeds to the process in Act 67.

In Act 67, the processor 41 determines whether or not the purchase-planned commodity in the non-purchased state exists in the shopping list stored in the RAM 43 or the auxiliary storage device 44. If there is a purchase-planned commodity in the non-purchased state in the shopping list stored in the RAM 43 or the auxiliary storage device 44, the processor 41 determines Yes in Act 67 and proceeds to the process in Act 68.

In Act 68, the processor 41 performs control to notify the operator of the user terminal 40 that there is the purchase-planned commodity which is not purchased yet. The notification is performed, for example, by displaying a screen or issuing a voice.

On the other hand, if there is no purchase-planned commodity in the non-purchased state in the shopping list, the processor 41 determines No in Act 67 and proceeds to the process in Act 69. The processor 41 proceeds to the process in Act 69 even after the process in Act 68.

In Act 69, the processor 41 inputs a settlement command to the self-scanning app to instruct execution of the settlement.

Meanwhile, if the settlement command is input in the standby state in Act 104 and Act 105 in FIG. 16, the processor 41 determines Yes in Act 105 and proceeds to the process in Act 108.

In Act 108, the processor 41 generates a settlement request for instructing execution of the settlement. The settlement request includes the purchase target list ID stored in the RAM 43 or the auxiliary storage device 44. Then, the processor 41 instructs the communication interface 45 to transmit the generated settlement request to the support server 10. Upon receiving the instruction, the communication interface 45 transmits the settlement request to the support server 10. The transmitted settlement request is received by the communication interface 15 of the support server 10.

Meanwhile, if the settlement request is received in the standby state in Act 221 to Act 224 in FIG. 18, the processor 11 of the support server 10 determines Yes in Act 224 and proceeds to the process in Act 228.

On the other hand, the operator of the user terminal 40 uses the camera 48 to read the barcode attached to the POS terminal 50 which performs the checkout.

In Act 109 in FIG. 16, the processor 41 of the user terminal 40 stands by until the barcode in which a POS ID is stored is read by the camera 48. If the barcode storing the POS ID is read, the processor 41 determines Yes in Act 109 and proceeds to the process in Act 110.

In Act 110, the processor 41 instructs the communication interface 45 to transmit the POS ID stored in the barcode read in Act 109 to the support server 10. Upon receiving the instruction, the communication interface 45 transmits the POS ID to the support server 10. The transmitted POS ID is received by the communication interface 15 of the support server 10.

Meanwhile, in Act 228 in FIG. 18, the processor 11 of the support server 10 waits for reception of the POS ID by the communication interface 15. If the POS ID is received, the processor 11 determines Yes in Act 228 and proceeds to the process in Act 229.

In Act 229, the processor 11 transmits the shopping list specified by the purchase target list ID contained in the settlement request received in the Act 224 and the transaction file associated with the target list to the POS terminal 50 specified by the POS ID.

Meanwhile, in Act 301 in FIG. 20, the processor 501 of the POS terminal 50 determines whether or not the shopping list and the transaction file are received by the communication interface 505. If the shopping list and the transaction file are not received, the processor 501 determines No in Act 301 and proceeds to the process in Act 302.

In Act 302, the processor 501 determines whether or not an operation for enabling the POS terminal 50 to log into the shopping support service is performed. If the operation for logging into the shopping support service is not performed, the processor 501 determines No in Act 302 and returns to the process in Act 301. Thus, the processor 501 repeats the processes in Act 301 and Act 302 until the shopping list and the transaction file are received or the operation for logging into the shopping support service is performed.

If the shopping list and the transaction file are received in the standby state in Act 301 and Act 302, the processor 501 determines Yes in Act 301 and proceeds to the process in Act 303.

In Act 303, the processor 501 stores the shopping list and the transaction file received in Act 301 in the RAM 503 or the auxiliary storage device 504.

In Act 304, the processor 501 displays the commodity list contained in the transaction file received in Act 301 on the display device 507.

In Act 305, the processor 501 displays the shopping list received in Act 301 on the customer-side touch panel 508.

The customer can log into the shopping support service using the POS terminal 50, for example, by operating the customer-side touch panel 508 and inputting the information necessary for login. By such an operation, the POS terminal 50 stores the member ID used for login in the auxiliary storage device 504 or the RAM 503.

If the operation for enabling the POS terminal 50 to log into the shopping support service is performed in the standby state in Act 301 and Act 302, the processor 501 determines Yes in Act 302 and proceeds to the process in Act 306.

Meanwhile, if the login is performed from the POS terminal 50 in the standby state in Act 201 to Act 203 in FIG. 17, the processor 11 of the support server 10 determines Yes in Act 203 and proceeds to the process in Act 231 in FIG. 18.

Meanwhile, in Act 306 in FIG. 20, the processor 501 acquires the shopping list from the support server 10. For example, the shopping list to be acquired here has the latest creation date and time among the shopping lists associated with the member ID in the auxiliary storage device 504 or the RAM 503. Alternatively, the shopping list acquired here is designated in advance by the member specified by the member ID.

In Act 307, the processor 501 determines whether or not an operation for completing the registration of the commodity and starting the settlement is performed. Specifically, the processor 501 determines whether or not a predetermined operation such as touching a subtotal button displayed on the display device 507 is performed. If the operation for instructing the completion of registration is not performed, the processor 501 determines No in Act 307 and proceeds to the process in Act 308.

In Act 308, the processor 501 determines whether or not the commodity ID is input. The commodity ID is input to the processor 501 as follows, for example. The operator of the POS terminal 50 uses the scanner 509 to read the barcode attached to the commodity. Thereby, the commodity ID recorded in the barcode is input to the processor 501. If the commodity ID is not input, the processor 501 determines No in Act 308 and returns to the process in Act 307. Thus, the processor 501 repeats the processes in Act 307 and Act 308 until the operation for starting settlement is performed or the commodity ID is input.

Meanwhile, in Act 111 in FIG. 16, the processor 41 of the user terminal 40 inputs a termination command in the list app. After the process in Act 111, the processor 41 terminates the self-scanning app.

Meanwhile, in Act 70 in FIG. 14, the processor 41 stands by until the termination command is input to the list app. If the termination command is input, the processor 41 determines Yes in Act 70 and returns to the process in Act 3 in FIG. 10.

Meanwhile, if the commodity ID is input in the standby state in Act 307 and Act 308, the processor 501 of the POS terminal 50 determines Yes in Act 308 and proceeds to the process in Act 309.

In Act 309, the processor 501 generates a purchase request for requesting to perform the purchase registration on the commodity specified by the commodity ID input in Act 308. The purchase request includes the purchase target list ID and the commodity ID input in Act 308. Then, the processor 501 instructs the communication interface 505 to transmit the generated purchase request to the support server 10. Upon receiving the instruction, the communication interface 505 transmits the purchase request to the support server 10. The transmitted commodity ID is received by the communication interface 15 of the support server 10.

Meanwhile, in Act 230 in FIG. 18, the processor 11 of the support server 10 determines whether or not the purchase request is received by the communication interface 15. If the purchase request is not received, the processor 11 determines No in Act 230 and proceeds to the process in Act 231.

In Act 231, the processor 11 determines whether or not the termination notification is received by the communication interface 15. If the termination notification is not received, the processor 11 determines No in Act 231 and returns to the process in Act 230. Thus, the processor 11 repeats the processes in Act 230 and Act 231 until the purchase request or the termination notification is received by the communication interface 15.

If the purchase request is received by the communication interface 15 in the standby state in Act 230 and Act 231, the processor 11 determines Yes in Act 230 and proceeds to the process in Act 241 in FIG. 19.

In a case of proceeding from Act 230 in FIG. 18 to Act 241 in FIG. 19, the communication interface 15 in Act 246 transmits the third completion notification to the POS terminal 50. The transmitted third completion notification is received by the communication interface 505 of the POS terminal 50. Similarly, in Act 254, the communication interface 15 transmits the confirmation request to the POS terminal 50. The transmitted confirmation request is received by the communication interface 505 of the POS terminal 50. Similarly, in Act 258, the communication interface 15 transmits the selection request to the POS terminal 50. The transmitted selection request is received by the communication interface 505 of the POS terminal 50.

If the transmission source of the purchase request is the POS terminal 50, the processor 11 determines Yes in Act 247 and returns to the process in Act 231 in FIG. 18.

Meanwhile, in Act 310 in FIG. 20, the processor 501 of the POS terminal 50 stands by until the completion notification such as the second completion notification or the third completion notification is received by the communication interface 505. If the completion notification is not received, the processor 501 determines No in Act 310 and proceeds to the process in Act 311.

In Act 311, the processor 501 determines whether or not the request such as the confirmation request or the selection request is received by the communication interface 505. If the request such as the communication confirmation request or the selection request is not received, the processor 501 determines No in Act 311 and returns to the process in Act 310. Thus, the processor 501 repeats the processes in Act 310 and Act 311 until the completion notification or the request is received. If the completion notification is received in the standby state in Act 310 and Act 311, the processor 501 determines Yes in Act 310 and proceeds to the process in Act 312.

In Act 312, the processor 501 adds the commodity specified by the commodity ID input in Act 308 to the commodity list stored in the auxiliary storage device 504. Based on the commodity list, the processor 501 updates the commodity list displayed on the display device 507.

As described above, even for the commodity whose barcode is not read by the self-scanning app, it is also possible to register it in the transaction list by reading the barcode in the POS terminal 50.

In Act 313, the processor 501 stores the shopping list contained in the second completion notification received in Act 310 in the RAM 503 or the auxiliary storage device 504. The processor 501 overwrites the shopping list already stored in the RAM 503 or the auxiliary storage device 504 with the shopping list and stores the overwritten shopping list. Based on the shopping list, the processor 501 updates the shopping list displayed on the customer-side touch panel 508. If the third completion notification is received in Act 310, the processor 501 skips the process in Act 313. After the process in Act 313, the processor 501 returns to the process in Act 307.

If the request such as the confirmation request or the selection request is received in the standby state in Act 310 and Act 311, the processor 501 determines Yes in Act 311 and proceeds to the process in Act 321 in FIG. 21.

In Act 321, the processor 501 determines whether or not the request received in Act 311 is the confirmation request. If the request received in Act 311 is the confirmation request, the processor 501 determines Yes in Act 321 and proceeds to the process in Act 322.

In Act 322, the processor 501 generates an image corresponding to the second confirmation screen. The processor 501 then instructs the customer-side touch panel 508 to display the generated image. Upon receiving the instruction, the customer-side touch panel 508 displays the second confirmation screen.

The second confirmation screen is used for inquiring of the operator of the POS terminal 50 about whether or not the target candidate contained in the confirmation request is exactly the alias of the commodity name contained in the confirmation request. The display content of the second confirmation screen is the same as that of the first confirmation screen.

In Act 323, the processor 501 stands by until the affirmation button B31 or the denial button B32 displayed on the second confirmation screen is operated. If the affirmation button B31 or the denial button B32 is operated, the processor 501 determines Yes in Act 323 and proceeds to the process in Act 324.

In Act 324, the processor 501 generates a confirmation response. Then, the processor 501 instructs the communication interface 505 to transmit the generated confirmation response to the support server 10. Upon receiving the instruction, the communication interface 505 transmits the confirmation response to the support server 10. The transmitted confirmation response is received by the communication interface 15 of the support server 10. After the process in Act 324, the processor 501 returns to the process in Act 310 in FIG. 20.

If the request received in Act 311 in FIG. 20 is not the confirmation request, the processor 501 determines No in Act 321 and proceeds to the process in Act 325.

In Act 325, the processor 501 determines whether or not the request received in Act 311 is the selection request. If the request received in Act 311 is not the selection request, the processor 501 determines No in Act 325 and performs a process in response to the received request. On the other hand, if the request received in Act 311 is the selection request, the processor 501 determines Yes in Act 325 and proceeds to the process in Act 326.

In Act 326, the processor 501 generates an image corresponding to the second selection screen. The processor 501 then instructs the customer-side touch panel 508 to display the generated image. Upon receiving the instruction, the customer-side touch panel 508 displays the second selection screen.

The second selection screen is used for inquiring of the operator of the POS terminal 50 about which the purchase-planned commodity contained in the shopping list specified by the purchase target list ID is indicated. The display content of the second selection screen is the same as that of the first selection screen.

In Act 327, the processor 501 stands by until any one of the plurality of selection buttons B41 and the denial button B42 is operated. If any one of the plurality of selection buttons B41 and the denial button B42 is operated, the processor 501 determines Yes in Act 327 and proceeds to the process in Act 328.

In Act 328, the processor 501 generates the selection response. Then, the processor 501 instructs the communication interface 505 to transmit the generated selection response to the support server 10. Upon receiving the instruction, the communication interface 505 transmits the selection response to the support server 10. The transmitted selection response is received by the communication interface 15 of the support server 10. After the process in Act 328, the processor 501 returns to the process in Act 310 in FIG. 20.

If the operation for completing the registration of the commodity is performed in the standby state in Act 307 and Act 308, the processor 501 determines Yes in Act 307 and proceeds to the process in Act 314.

In Act 314, the processor 501 determines whether or not the purchase-planned commodity in the non-purchased state exists in the shopping list stored in the RAM 503 or the auxiliary storage device 504. If there is the purchase-planned commodity in the non-purchased state in the shopping list stored in the RAM 503 or the auxiliary storage device 504, the processor 501 determines Yes in Act 314 and proceeds to the process in Act 315.

In Act 315, the processor 501 performs controls to notify the customer that there is a purchase-planned commodity which is not purchased yet. The notification is performed, for example, by displaying a screen or issuing a voice.

On the other hand, if the purchase-planned commodity which is not yet purchased does not exist in the shopping list stored in the RAM 503 or the auxiliary storage device 504, the processor 501 determines No in Act 314 and proceeds to the process in Act 316. The processor 501 also proceeds to the process in Act 316 after the process in Act 315.

In Act 316, the processor 501 performs the settlement process based on the commodity ID registered in the commodity list. The processor 501 acquires the amount of the commodity indicated by the commodity ID and the commodity name from the commodity DB241. Since the settlement process is a well-known process, a detailed description thereof is omitted.

In Act 317, the processor 501 controls the printer to issue a receipt based on the settlement content in Act 316.

In Act 318, the processor 501 instructs the communication interface 505 to transmit a commodity sales history based on the settlement content in Act 316 to the POS server 20. Upon receiving the instruction, the communication interface 505 transmits the commodity sales history to the POS server 20. The commodity sales history also includes the list ID of the shopping list stored in the RAM 503 or the auxiliary storage device 504. The transmitted commodity sales history is received by the communication interface 25 of the POS server 20. The POS server 20 stores the commodity sales history in the history DB242 by adding a record corresponding to each commodity settled in Act 316 to the history table T12 based on the commodity sales history. The POS server 20 stores the information in which the transaction ID corresponding to the received commodity sales history is associated with the list ID contained in the commodity sales history in the history DB242.

In Act 319, the processor 501 instructs the communication interface 505 to transmit the termination notification indicating that the settlement is completed to the support server 10. Upon receiving the instruction, the communication interface 505 transmits the termination notification to the support server 10. The transmitted termination notification is received by the communication interface 15 of the support server 10. After the process in Act 319, the processor 501 returns to the process in Act 301.

Meanwhile, if the termination notification is received by the communication interface 15 in the standby state in Act 230 and Act 231 in FIG. 18, the processor 11 of the support server 10 determines Yes in Act 231 and returns to the process in Act 201 in FIG. 17.

According to the support system 1 of the embodiment, the support server 10 decides the name of the purchase-planned commodity contained in most shopping lists among the shopping lists in which the commodity is associated with the registration target ID as the alias of the commodity specified by the registration target ID. Therefore, the support server 10 can automatically update the linkage dictionary. Therefore, it is not necessary to create or update a linkage dictionary through the input by the user, which is convenient.

According to the support system 1 of the embodiment, the support server 10 confirms whether the alias of the commodity name is exact based on the operation by the operator by displaying the confirmation screen. Therefore, the support server 10 can prevent a wrong alias from being associated with the commodity name.

According to the support system 1 of the embodiment, if the commodity name or the alias of the commodity specified by the registration target ID does not match the purchase-planned commodity contained in the shopping list, the registration target ID is associated with the list ID of the shopping list by using the association table T5. By doing this, it is possible to perform a retrieval at high speed to specify the alias of the commodity specified by the registration target ID. In a case in which such association is not performed, the processor 11 needs to refer to the list DB 142 and the history DB 242, for example.

According to the support system 1 of the embodiment, with the support server 10, the operator can select a purchase-planned commodity contained in the shopping list according to the commodity name of the commodity specified by the registration target ID. The support server 10 then determines the name of the purchase-planned commodity as an alias of the commodity specified by the registration target ID. Therefore, it is not necessary for the administrator or the like of the support system 1 to manually create or update a linkage dictionary. For this reason, the trouble of the administrator of the support system 1 is reduced.

The support system 1 of the embodiment can log into the shopping support service using the POS terminal 50. Therefore, the user of the shopping support service can use the shopping support service even if he/she does not carry the portable user terminal 40.

According to the support system 1 of the embodiment, the support server 10 sets the purchase-planned commodity to the purchased state if there is the purchase-planned commodity in the shopping list, which has the name matching with the commodity name or the alias of the commodity whose commodity ID is read by using the self-scanning app. Therefore, the operator of the user terminal 40 can update both the shopping list relating to the list service and the transaction file relating to the self-scanning service by reading the barcode attached to the commodity at once.

The above embodiment may also be modified as follows.

In the above embodiment, the linkage dictionary associates the commodity name with the alias. However, in the linkage dictionary, two names may be associated with each other in addition to the association between the commodity name and the alias.

The support server 10 may perform the retrieval for specifying the alias of the commodity specified by the registration target ID by referring to the list DB 142 and the history DB 242 instead of the association table T5. In the list DB 142 and the history DB 242, the purchased commodity purchased based on the shopping list is associated with the shopping list.

In the above embodiment, two methods including a method shown in Act 251 to Act 257 and a method shown in Act 258 to Act 261 are used to update the linkage dictionary. However, the support system 1 may use either of the two methods.

The user terminal 40 may input the name of the purchase-planned commodity taken from the display place and then placed in the basket by inputting character, handwriting, voice or the like. In this case, the processor 11 of the support server 10 can refer to the linkage dictionary to set the purchase-planned commodity having the same name as the alias of the input name to the purchased state.

In the above embodiment, the update of the linkage dictionary is performed in response to the execution of the commodity purchase registration. However, the processor 11 may update the linkage dictionary during a time period such as nighttime, in which computational resources remain, for example. In this case, for example, the processor 11 performs the same processes as in Act 252 to Act 257 by using each commodity ID contained in the commodity DB 241 instead of the registration target ID. However, in this case, the processor 11 skips the process in Act 254 to Act 256. Furthermore, the threshold value in this case may be a value different from that in the above embodiment.

The user terminal 40 may be a digital signage or a distributed kiosk terminal installed in retail store. A plurality of the digital signage or distributed kiosk terminal is installed in, for example, the retail store. The customer logs into the list service and the self-scanning service using anyone of the digital signage or the distributed kiosk terminal in the vicinity after taking the commodity from the display shelf. The customer then performs an operation for setting the purchase-planned commodity corresponding to the commodity to the purchased state. In this case, the user of the shopping support service can use the shopping support service even if he/she does not carry the portable user terminal user terminal 40.

The user terminal 40 maybe a terminal attached to a shopping basket or the like. The customer logs into the list service and the self-scanning service using the terminal. Then, the customer takes a commodity from the display shelf and puts it in the basket. At this time, the customer performs the operation for setting the purchase-planned commodity corresponding to the commodity to the purchased state. In this case, the customer can use the shopping support service even if he/she does not carry the portable user terminal 40.

The customer can use the shopping list with the above digital signage and distributed kiosk terminal, or the terminal installed in the shopping basket after the creation of the shopping list is previously performed with the PC.

The user terminal 40 or the POS terminal 50 may be provided with a card reader for reading an IC (integrated circuit) card. In this case, the operator may log into the list service and the self-scanning service by reading the IC card with the user terminal 40. In this case, the operator of the user terminal 40 or the POS terminal 50 does not need to input the login ID. Since the member card of the retail store can be used as the IC card used for login, it is particularly preferable to use the above digital signage or distributed kiosk terminal, or the terminal installed in the shopping basket.

The user terminal 40 or the POS terminal 50 may include a device for performing biometric authentication. In this case, it is possible to log into the list service and the self-scanning service by performing the biometric authentication. In this case, the operator of the user terminal 40 or the POS terminal 50 does not need to input the login ID. Furthermore, the operator of the user terminal 40 or the POS terminal 50 does not need to carry the IC card for login. Therefore, it is particularly preferable to use the above digital signage or distributed kiosk terminal, or the terminal installed in the shopping basket.

The user terminal 40 may be provided with a scanner for reading the barcode instead of the camera 48.

In the support system 1, an IC tag may be used instead of the barcode. In this case, the user terminal 40 and the POS terminal 50 read the IC tag instead of the barcode. The user terminal 40 and the POS terminal 50 read the IC tag using a NFC (near field radio communication) reader or the like.

The user terminal 40 may perform a part of the processes performed by the support server 10 in the above embodiment. The support server 10 may perform a part of the processes performed by the user terminal 40 in the above embodiment.

The POS terminal 50 may perform a part of the processes performed by the support server 10 in the above embodiment. The support server 10 may perform a part of the processes performed by the POS terminal 50 in the above embodiment.

Therefore, the support server 10, the user terminal 40 or the POS terminal 50 is an example of the shopping support apparatus. Alternatively, the support server 10 and the user terminal 40 cooperate with each other to operate as the shopping support apparatus. Alternatively, the support server 10 and the POS terminal 50 cooperate with each other to operate as the shopping support apparatus. The support system 1 is an example of the shopping support apparatus.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A shopping support server having improved transaction throughput as a result of a more accurate matching of items that are selected for purchase to items that are contained in a shopping list, comprising:
a communication interface through which a code of an item to be purchased is received; and
a processor configured to associate a first name with a second name, which is the name of the item to be purchased, if prior shopping lists having an item with the first name and associated with the item to be purchased satisfy a predetermined condition, and register as purchased an item in a current shopping list that has the first name.

2. The shopping support server according to claim 1, wherein
the controller is configured to wait for a confirmation input prior to registering the item in the current shopping list as purchased.

3. The shopping support server according to claim 2, wherein the processor is configured to update a dictionary database to add the first name as being associated with the second name.

4. The shopping support apparatus according to claim 1, wherein
the controller is configured to wait for a manual selection of one of the items in the current shopping list as corresponding to the item to be purchased if the predetermined condition is not satisfied.

5. The shopping support server according to claim 4, wherein
the processor is configured to update a dictionary database to add a name of said one of the items in the current shopping list as being associated with the second name after the manual selection.

6. The shopping support server according to claim 1, wherein the predetermined condition is satisfied if the number of items in the prior shopping lists that have the first name is greater than a threshold number.

7. The shopping support server according to claim 1, wherein the predetermined condition is satisfied if the number of the prior shopping lists divided by the total number of shopping lists stored in the shopping support apparatus is greater than a threshold number.

8. The shopping support server according to claim 1, wherein the predetermined condition is satisfied if the number of items in the prior shopping lists that have the first name divided by the number of the prior shopping lists is greater than a threshold number.

9. The shopping support server according to claim 1, wherein
the controller is further configured to associate a third name that is selected on an input interface to the second name, wherein
the third name is a name of one of the items in the shopping list.

10. The shopping support server according to claim 9, wherein the input interface is displayed on a user terminal and the selection of the third name is made using the user terminal.

11. The shopping support server according to claim 10, wherein the code of the item to be purchased is read using a camera of the user terminal.

12. A shopping support method having improved transaction throughput as a result of a more accurate matching of items that are selected for purchase to items that are contained in a shopping list, said method comprising:
receiving a code of an item to be purchased; and
associating a first name with a second name, which is the name of the item to be purchased, if prior shopping lists having an item with the first name and associated with the item to be purchased satisfy a predetermined condition; and
registering as purchased an item in a current shopping list that has the first name.

13. The shopping support method according to claim 12, further comprising:
waiting for a confirmation input prior to registering the item in the current shopping list as purchased.

14. The shopping support method according to claim 13, further comprising:
updating a dictionary database to add the first name as being associated with the second name.

15. The shopping support apparatus according to claim 12, further comprising:
waiting for a manual selection of one of the items in the current shopping list as corresponding to the item to be purchased if the predetermined condition is not satisfied.

16. The shopping support method according to claim 15, further comprising:
updating a dictionary database to add a name of said one of the items in the current shopping list as being associated with the second name after the manual selection.

17. The shopping support method according to claim 12, wherein the predetermined condition is satisfied if the number of items in the prior shopping lists that have the first name is greater than a threshold number.

18. The shopping support method according to claim 12, wherein the predetermined condition is satisfied if the number of the prior shopping lists divided by the total number of shopping lists stored in the shopping support apparatus is greater than a threshold number.

19. The shopping support method according to claim 12, wherein the predetermined condition is satisfied if the number of items in the prior shopping lists that have the first name divided by the number of the prior shopping lists is greater than a threshold number.

20. The shopping support method according to claim 12, further comprising:
reading the code of the item to be purchased using a camera of a user terminal.
